(19) United States
(12) Patent Application Publication
(10) Pub. No.: US 2015/0153834 A1
(43) Pub. Date: Jun. 4, 2015

(54) MOTION INPUT APPARATUS AND MOTION INPUT METHOD

(71) Applicant: FUJITSU LIMITED, Kawasaki-shi (JP)

(72) Inventors: Katsuhiko AKIYAMA, Kawasaki (JP); Koki HATADA, Kawasaki (JP)

(73) Assignee: FUJITSU LIMITED, Kawasaki-shi (JP)

(21) Appl. No.: 14/548,789

(22) Filed: Nov. 20, 2014

(30) Foreign Application Priority Data
Dec. 3, 2013 (JP) 2013-250160

(51) Int. Cl. G06F 3/01

(52) U.S. Cl. CPC G06F 3/017

(57) ABSTRACT

The motion input apparatus includes a display configured to display an operation object, and one or more processors configured to acquire a position of a motion part related to a motion input of a user, and switch over a status of the motion input apparatus, when detecting an operation satisfying a predetermined operation condition for the operation object displayed on the display from the acquired position of the motion part, to a valid status in which operations based on the motion input of the user are valid from an invalid status in which operations based on the motion input of the user are invalid.

### CROSS-REFERENCE TO RELATED APPLICATION

This application is based upon and claims the benefit of priority of the prior Japanese Patent Application No. 2013-250160, filed on Dec. 3, 2013, the entire contents of which are incorporated herein by reference.

### FIELD

The embodiments discussed herein are related to a motion input apparatus and a motion input method.

### BACKGROUND

There has hitherto been known an information processing apparatus equipped with input devices, i.e., an image capturing device such as a camera and a sound device such as a microphone. In the information processing apparatus equipped with the input devices, a predetermined operation instruction is executed through a motion or a voice/sound of an operator (user), which is detected via the input devices serving as user interfaces (UIs).

For example, the information processing apparatus including the input device, i.e., the image capturing device such as the camera, detects a predetermined specific motion such as a hand gesture and a hand sign intended by the operator (user) with an image being captured, and switches over a status of an input operation based on the detected motion to a valid status or an invalid status. The predetermined motion includes, for instance, an action using a part of a user's body such as protruding a hand and inclining a head, and an operation of an operation device etc. having a light emitting element of infrared-rays etc.

The information processing apparatus, if the detected specific motion is a motion to set an operation input based on an image captured by the camera etc. in the valid status, switches over, e.g., its status to the valid status from the invalid status, and executes the predetermined operation instruction corresponding to the continuously detected motion of the user. On the other hand, the information processing apparatus, if the detected specific motion is a motion to set the operation input based on the image captured by the camera etc. in the invalid status, switches over, e.g., its status to the invalid status from the valid status, and invalidates the operation input based on the captured image. The information processing apparatus including the input device, i.e., the sound device such as the microphone similarly detects a predetermined voice/sound such as user's utterance containing a word becoming a keyword and a predetermined operation sound, and switches over a status of the input operation based on the detected voice/sound to the valid status or the invalid status.

It is to be noted that the following Patent documents exist as prior art documents describing technologies related to the technology, which will be discussed in the present specification.

[Patent document 1] Japanese Laid-Open Patent Publication No. 2011-221672
[Patent document 2] Japanese Laid-Open Patent Publication No. 2000-196914
[Patent document 3] Japanese Laid-Open Patent Publication No. 2010-176510

### SUMMARY

An aspect of the embodiments is exemplified by a configuration of a motion input apparatus which follows. Namely, the motion input apparatus includes a display configured to display an operation object, and one or more processors configured to acquire a position of a motion part related to a motion input of a user, and switch over a status of the motion input apparatus, when detecting an operation satisfying a predetermined operation condition for the operation object displayed on the display from the acquired position of the motion part, to a valid status in which operations based on the motion input of the user are valid from an invalid status in which operations based on the motion input of the user are invalid.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF THE DRAWINGS

FIG. 1 is an explanatory diagram of a motion input apparatus according to an embodiment;

FIG. 2 is a diagram illustrating a hardware configuration of the motion input apparatus according to the embodiment;

FIG. 3 is a diagram illustrating a functional configuration of the motion input apparatus according to the embodiment;

FIG. 4A is an explanatory diagram of a tracking example using infrared rays etc.;

FIG. 4B is an explanatory diagram of an operation effective area;

FIG. 5 is an explanatory diagram of a crossing-based operation method;

FIG. 6A is a flowchart illustrating a mode switchover process;

FIG. 6B is a flowchart illustrating the mode switchover process;

FIG. 6C is a flowchart illustrating the mode switchover process;

FIG. 6D is a flowchart illustrating a process of determining a mode switchover to an invalid status by use of the operation effective area;

FIG. 6E is a f flowchart illustrating a process of determining the mode switchover to the invalid status by use of a detection of a direction of a face; and

FIG. 6F is a flowchart illustrating a process of determining the mode switchover to the invalid status by setting it as a condition that the cursor passes over a plurality of areas on a display screen.

### DESCRIPTION OF EMBODIMENTS

An UI configured to detect a motion or a voice/sound of a user by use of a predetermined input device and to reflect the detected motion or the voice/sound as an operation instruction to an information processing apparatus etc. including an input device, will be referred to as a non-contact type UI in the following discussion. The user's motion, voice/sound, etc. inputted via the non-contact type UI will be termed operation inputs.

In the information processing apparatus equipped with the non-contact type UI, the user performs the predetermined specific hand gesture and hand sign, makes utterance and operates the operation object while being aware thereof whenever switching over the status of the non-contact type UI to the valid or invalid status. Therefore, when switching over the status of the non-contact type UI making use of the specific motion to the valid or invalid status, the user feels it troublesome to perform the specific motion and action while being aware thereof as the case may be.

On the other hand, in the information processing apparatus etc. equipped with the non-contact type UI, there is a case in which it is difficult to determine whether or not the motion input of the user's motion or voice/sound detected by the input device is based on the action in which the user's intention is reflected. For instance, this is a case in which the detected motion of the user is the predetermined motion such as scratching the head, putting the user's hand on his or her chin, and conversing with another user while making the hand gesture, which are associated with instructive operations, but is derived from an unconscious action conducted irrespective of the user's operational intention. The information processing apparatus etc. detects the motion derived from the unconscious action conducted irrespective of the user's operational intention and results in determining this motion to be an input of the operation instruction. Hence, the information processing apparatus etc. causes functioning not conforming with the user's intention as the case may be.

A motion input apparatus according to one embodiment will hereinafter be described with reference to the drawings. A configuration of the following embodiment is an exemplification, and the motion input apparatus is not limited to the configuration of the embodiment.

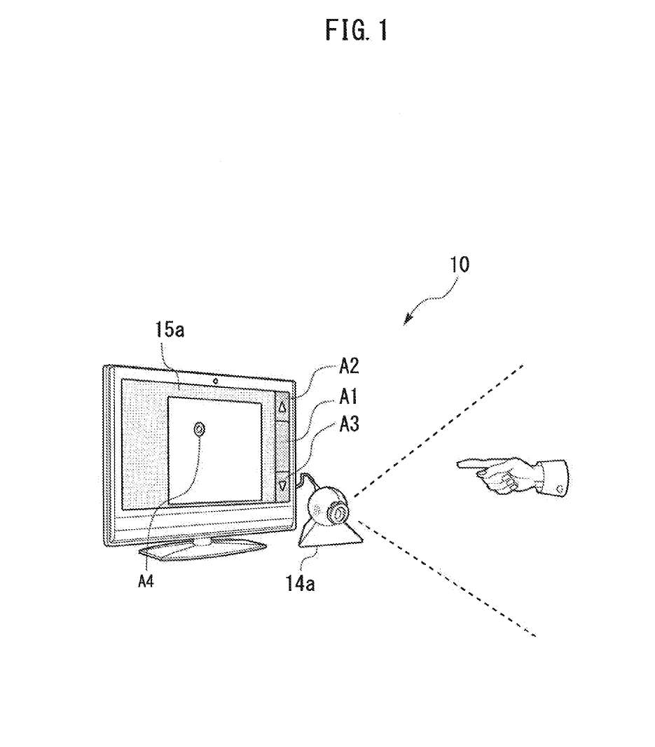

The motion input apparatus will hereinafter be described based on the drawings of FIGS. 1 through 6.

### Example 1

FIG. 1 illustrates an explanatory diagram for explaining the motion input apparatus according to the embodiment. A motion input apparatus 10 according to the embodiment is an information processing apparatus exemplified by a PC (Personal Computer) etc. including an input device equipped with an image capturing device such as a camera 14a. Further, the motion input apparatus 10 according to the embodiment includes a display device such as an LCD (Liquid Crystal Display) 15a. The motion input apparatus according to the embodiment may also include the input device equipped with a device such as a microphone that inputs sounds. The motion input apparatus 10 has a non-contact type UI (User Interface) function by which to reflect a motion form such as a motion of a hand of an operator (who will hereinafter be referred to as a user), the motion being detected by the input device, by way of an operation instruction given to the motion input apparatus 10.

In the explanatory diagram illustrated in FIG. 1, an operation screen for application software (which will hereinafter be simply termed the application) operated by the non-contact type UI function is displayed on a display screen of the LCD 15a. In the illustrated operation screen, a scroll bar defined as an operation object (which will hereinafter be also referred to as a UI object), which can be operated by the non-contact type UI function, is displayed in a display area A1. An operation button defined as an operation component of the scroll bar in the display area A1, this button serving to move a display area of image information displayed on the LCD 15a upward within a display target range, is displayed in a display area A2. Displayed likewise in a display area A3 is an operation button serving to move the display area of the image information displayed on the LCD 15a downward within the display target range.

Further, a cursor for updating a display position corresponding to the motion of the hand etc. of the user, the motion being detected by the input device, is displayed in a display position A4 on the illustrated operation screen. The cursor in the display position A4 changes the display position following, e.g., the motion of the hand etc. of the user, thereby moving the display area on the screen of the LCD 15a.

In the explanatory diagram illustrated in FIG. 1, the user performing the operation based on a motion input through the non-contact type UI function faces the LCD 15a on which, e.g., an application screen is displayed, and also faces the camera 14a for capturing an image of the operation based on the motion input of the user. The motion input apparatus 10 grasps the motion form of the motion etc. of the user in a face-to-face relationship with the camera 14a as the operation based on the motion input of the user, and reflects the captured motion form in the display position of the cursor to move the display area of the LCD 15a on which to display, e.g., the application screen.

In the motion input apparatus 10 illustrated in FIG. 1, a valid status and an invalid status of the non-contact type UI function are switched over based on the motion of the hand etc. of the user, which is detected by, e.g., the input device. The motion of the hand etc. of the user related to the valid status and the invalid status of the non-contact type UI function, is identified from time series of the images captured by the camera 14a. Note that the valid status of the non-contact type UI function is also termed a valid mode, while the invalid status of the non-contact type UI function is also termed an invalid mode in the following discussion. Moreover, the switchover of the valid and invalid statuses of the non-contact type UI function is also termed a mode switchover.

In the mode switchover of the motion input apparatus 10 using the image capturing device like the camera, such a task will hereinafter be examined as to detect a user's specific motion like a predetermined hand gesture, a predetermined hand sign, etc. from, e.g., the time series of the captured images and to shift to a predetermined mode. For example, there is examined a task that the motion input apparatus 10 detects a motion of making a predetermined posture and a motion of doing a predetermined gesture by use of the user's own hand, and performs the switchover from the invalid mode to the valid mode. Moreover, such a task is also examined that the motion input apparatus 10 detects a predetermined number of motions within a predetermined period of time, e.g., repetitive motions of making the hand gestures to protrude or move the specific hand sign in an oblique direction, and performs the switchover from the invalid mode to the valid mode.

When the motion input apparatus 10 switches over the mode through the operation etc. based on the motion input of the specific hand sign or hand gesture, the user frequently executes the predetermined specific motion while being aware of this motion each time the mode is switched over and feels troublesome as the case may be. Furthermore, the hand gesture for switching over the mode may include, e.g., scratching the user's head, putting the user's hand on his or her chin, etc., in which case a device operation not being intended by the user may occur based on the detected user's motion, resulting in causing a mis-operation or a malfunction of the operation device.

Further, for instance, when the motion input apparatus 10 detects a static state of the user for a predetermined or longer period of time on the display screen etc., it is considered that the motion input apparatus 10 switches over the mode to the valid mode due to detecting the user's motion such as the specific hand gesture. A combination of the screen status and the user's motion enables accuracy of the motion input to be increased in a way that prevents the device operation not being intended by the user, however, there remains the troublesomeness about conducting the motion input while being aware of the respective combinations thereof. The user frequently performs the motion input while being aware of the combination of the screen status and the motion input whenever switching over the mode, and hence there is a case of the user's feeling troublesome and hard to use the non-contact type UI.

The same is applied to the case of using the sound device etc. such as the microphone, in which the user conducts the motion input while being aware of a user's utterance containing a word becoming a keyword and a predetermined sound like a predetermined operation sound etc. whenever switching over the mode. Therefore, the user feels troublesome and hard to use the non-contact type UI via which to perform the specific behavior while being aware thereof as the case may be.

The motion input apparatus 10 according to the embodiment detects, for example, as illustrated in FIG. 1, the operation based on the user's motion input for the UI object such as the bottom and the scroll bar of the operation target application, which are displayed on the screen of the LCD 15a defined as the display device. The user's motion input for the UI object, which is detected by the motion input apparatus 10 according to the embodiment, is the motion input that is substantially the same as the operation for the UI object displayed on the screen when the non-contact type UI function is in the valid status.

Then, the motion input apparatus 10 according to the embodiment, for instance, if the operation based on the detected user's motion input satisfies a predetermined condition about a display position of the UI object, switches over the mode to the valid mode from the invalid mode. Herein, the “predetermined condition” can be exemplified by, e.g., the number of detections of the operation based on the user's motion input with respect to the display position of the UI object such as the button and the scroll bar displayed on the screen of the LCD 15a. Furthermore, for instance, if the number of operations based on the user's motion input conducted with respect to the display position of the UI object exceeds a predetermined number of times, the motion input apparatus 10 can switch over the mode from the invalid mode to the valid mode. This is because if the number of operations based on the user's motion input with respect to the display position of the UI object exceeds the predetermined number of times, it can be determined that the user performs the motion input with an intention to switch over the mode. Note that the condition for switching over the mode may include a condition that the number of detections of the operation based on the user's motion input conducted within a predetermined period of time with respect to the UI object is counted, and a count value thereof exceeds the predetermined number of times. A timewise restrictive condition is added to the number of detections, whereby it is feasible to determine a switchover intention of the user performing the motion input and to consequently enhance accuracy for the determination.

In the example of FIG. 1, the motion input apparatus 10 according to the embodiment detects, e.g., the operation based on the user's motion input with respect to the display position of the UI object such as the button and the scroll bar in the area A displayed on the screen of the LCD 15a in, e.g., the invalid mode. Then, the motion input apparatus 10 counts, e.g., the number of operations based on the user's motion input with respect to the display position of the UI object, and, if the count value given by counting exceeds the predetermined number of times, switches over the mode to the valid mode.

The motion input apparatus 10 according to the embodiment detects the operations based on the user's motion input when in the valid mode with respect to the UI object displayed on the screen during the invalid mode, and, if satisfying such a predetermined condition that the number of detected operations based on the user's motion input is equal to or larger than the predetermined number of times, shifts to the valid mode. The motion input apparatus 10 according to the embodiment can switch over the mode during the invalid mode through the operation based on the user's motion input assumed to be executed with respect to the display position of the UI object on the display screen when the non-contact type UI function is valid. Therefore, in the motion input apparatus 10 according to the embodiment, the user does not execute the motion input of the specific hand gesture, hand sign, sound, etc. related to the operation while being aware of shifting the mode of the non-contact type UI function from the invalid mode to the valid mode.

The motion input apparatus 10 according to the embodiment can execute switching over the mode through substantially the same operation based on the user's motion input as in the case where the non-contact type UI function is in the valid status with respect to the UI object displayed on the screen. Accordingly, when the non-contact type UI function returns to the valid status from the invalid status, as compared with the case of performing the motion input of the specific hand sign, hand gesture, etc., it is possible to improve user-friendliness to the non-contact type UI. Moreover, the motion input apparatus 10 according to the embodiment can set, as the condition for switching over the mode, e.g. the number of detections of the operation based on the user's motion input with respect to the UI object displayed on the screen during the invalid mode. The motion input apparatus 10 according to the embodiment is therefore capable of preventing the mis-operation and the malfunction of the operation device due to an unaware behavior conducted irrespective of the user's intention. As a result, the motion input apparatus 10 according to the embodiment can improve usability, i.e., ease-of-use or the user-friendliness to the non-contact type UI.

### [Configuration of Apparatus]

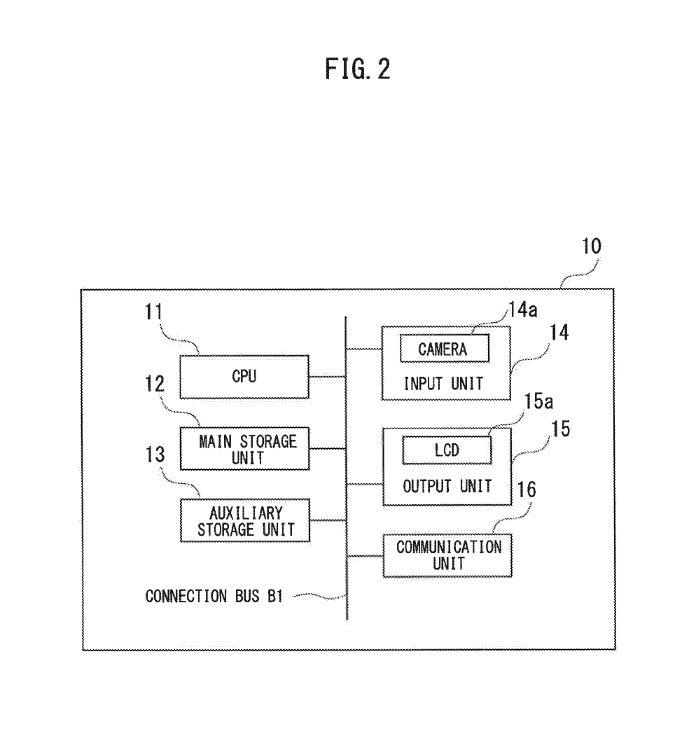

FIG. 2 illustrates a hardware configuration of the motion input apparatus 10. The motion input apparatus illustrated in FIG. 2 has so-called computer architecture. The motion input apparatus 10 includes a CPU (Central Processing Unit) 11, a main storage unit 12, an auxiliary storage unit 13, an input unit 14, an output unit 15 and a communication unit 6, which are all interconnected via a connection bus B1. The main storage unit 12 and the auxiliary storage unit 13 are recording mediums readable by the motion input apparatus 10.

The motion input apparatus 10 deploys a program stored on the auxiliary storage unit 13 onto an operation area of the main storage unit 12 so that the CPU 11 can execute the program, and controls peripheral devices through the execution of the program. The motion input apparatus 10 is thereby enabled to realize a function conforming to a predetermined purpose.

In the motion input apparatus 10 depicted in FIG. 2, the CPU 11 is a central processing unit that controls the motion input apparatus 10 as a whole. The CPU 11 executes processes in accordance with the program stored on the auxiliary storage unit 13. The main storage unit 12 is a storage medium configured for the CPU 11 to cache the program and data and to deploy the operation area. The main storage unit 12 includes, e.g., a RAM (Random Access Memory) and a ROM (Read Only Memory).

The auxiliary storage unit 13 stores a variety of programs and various items of data on the storage medium in a readable/writable manner. The auxiliary storage unit 13 is also called an external storage device. The auxiliary storage unit 13 stores an Operating System (OS), the variety of program, a variety of tables, etc. The OS includes a communication interface program that receives and transfers the data from and to external devices etc. connected via the communication unit 16. The external devices include, e.g., other information processing apparatuses such as PCs and servers, other external storage devices, etc. on an unillustrated network.

The auxiliary storage unit 13 is exemplified such as an EPROM (Erasable Programmable ROM), a solid-state drive device and a hard disk drive (HDD) device. For example, a CD drive device, a DVD drive device, a BD drive device, etc. can be presented as the auxiliary storage unit 13. The recording medium is exemplified such as a silicon disc including a nonvolatile semiconductor memory (flash memory), a hard disk, a CD, a DVD, a BD, a USB (Universal Serial Bus) memory and a memory card.

The input unit 14 accepts an operation instruction etc. from the user etc. The input unit 14 is an input device such as the camera 14a, an input button, a keyboard, a trackball, a pointing device, a wireless remote controller and a microphone. The CPU 11 is notified of information inputted from the input unit 14 via the connection bus B1. For example, the CPU 11 is notified of information of the images captured by the camera 14a and information of sounds detected by the microphone via the connection bus B1.

The output unit 15 outputs the data to be processed by the CPU 11 and the data to be stored on the main storage unit 12. The output unit 15 includes a display device such as the LCD 15a, a CRT (Cathode Ray Tube) display, a PDP (Plasma Display Panel), an EL (Electroluminescence) panel and an organic EL panel. Further, the output unit 15 includes an output device such as a printer and a loudspeaker. The communication unit 16 is, e.g., an interface with the network etc. to which the motion input apparatus 10 is connected.

Herein, the LCD 15a of the motion input apparatus 10 is one example of a display unit to display an operation object. Further the display unit is one example of a display. The camera 14a of the motion input apparatus 10 is one example of an image capturing device to capture an operation based on a user's motion input.

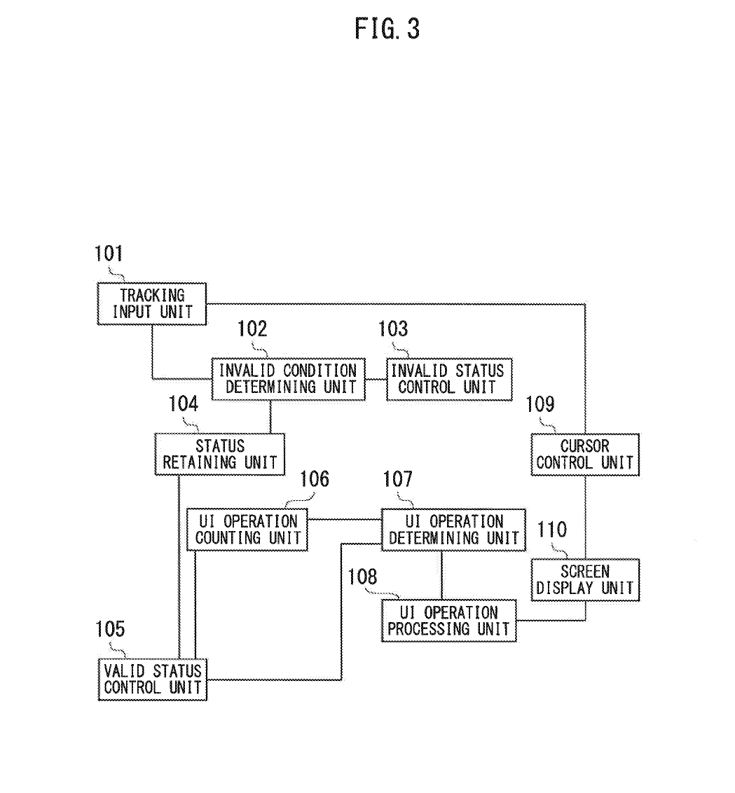

The CPU 11 reads the OS, the variety of programs and the various items of data stored on the auxiliary storage unit 13 into the main storage unit 12, and executes the readout OS, programs and data, whereby the motion input apparatus 10 realizes respective functional means illustrated in FIG. 3 in conjunction with executing the target programs.

The motion input apparatus 10 realizes, in conjunction with executing the target programs, a tracking input unit 101, an invalid condition determining unit 102, an invalid status control unit 103, a status retaining unit 104 and a valid status control unit 105, which are illustrated in FIG. 3. The motion input apparatus 10 further realizes a UI operation counting unit 106, a UI operation determining unit 107, a UI operation processing unit 108, a cursor control unit 109 and a screen display unit 110, which are illustrated in FIG. 3.

Note that any one of the respective functional means may be included in another information processing apparatus etc. For instance, the motion input apparatus 10 includes the tracking input unit 101, the status retaining unit 104, the cursor control unit 109 and the screen display unit 110, and is connected via the network to an information processing apparatus including the invalid condition determining unit 102 and an information processing apparatus including the invalid status control unit 103. Connected then to this network are an information processing apparatus including the valid status control unit 105, an information processing apparatus including the UI operation counting unit 106, an information processing apparatus including the UI operation determining unit 107 and an information processing apparatus including the UI operation processing unit 108. Thus, the motion input apparatus 10 may function by distributing the functional means to a plurality of information processing apparatuses and realizing these respective functional means. The motion input apparatus 10 can be realized by way of, e.g., a cloud system defined as a group of computers on the network and is therefore enabled to reduce processing loads on the respective functional means.

However, the motion input apparatus 10 may be configured integrally with, e.g., the camera 14a. Moreover, for instance, an information processing apparatus including the screen display unit 110 may function as the motion input apparatus 10 by connecting with the camera 14a including other functional units exclusive of the screen display unit 110.

### [Configuration of Functional Blocks]

FIG. 3 illustrates an explanatory diagram of functional blocks in the motion input apparatus 10 according to the embodiment. In the explanatory diagram depicted in FIG. 3, the motion input apparatus 10 includes the respective functional means such as the tracking input unit 101, the invalid condition determining unit 102, the invalid status control unit 103, the status retaining unit 104 and the valid status control unit 105. The motion input apparatus 10 further includes the UI operation counting unit 106, the UI operation determining unit 107, the UI operation processing unit 108, the cursor control unit 109 and the screen display unit 110. Note that the motion input apparatus 10 includes, e.g., the auxiliary storage unit 13 to which the respective functional means described above refer or serving as a storage destination of the data to be managed in the explanatory diagram illustrated in FIG. 3.

The tracking input unit 101 depicted in FIG. 3 grasps a position of an operation part of the user performing the motion input, e.g., from the time series of the images captured by the camera 14a etc. The operation part of the user can be exemplified by a hand, an arm, a face, etc. of the user. The following discussion will be made on the assumption that the tracking input unit 101 grasps the user's hand as the operation part and acquires positional information. Moreover, an event of grasping the operation part and following the operation of the user is to be called “tracking” in the embodiment.

It is to be noted that the acquired positional information of the hand may be 2-dimensional coordinate information represented by, e.g., (X, Y), and may also be 3-dimensional coordinate information represented by (X, Y, Z) in which a depth information is reflected in a Z-coordinate. The positional information of the hand is represented by the 2-dimensional coordinate information, in which case the Y-axis defines, e.g., a vertical direction, and the X-axis defines a horizontal direction. The positional information of the hand is represented by the 3-dimensional coordinate information, in which case the Z-axis defines a direction of the user positioned in the face-to-face relationship with the camera 14a. The positional information acquired by the tracking input unit 101 is temporarily stored, e.g., in a predetermined area of the main storage unit 12 of the motion input apparatus 10. The hand positional information acquired by the tracking input unit 101 is handed over to, e.g., the invalid condition determining unit 102 and the cursor control unit 109. Note that image information containing the hand positional information acquired by the tracking input unit 101 is updated at an interval of a predetermined period of time such as 1/30 sec.

A method of detecting the position etc. of the user's hand from the time series of the images captured by the camera 14a etc. can be exemplified by an optical flow etc. for tracking an object by associating the respective parts contained in the captured images acquired in time-series. Further, for instance, a Mean-Shift tracking method, a Lucas-Kanade method, a method using a particle filter, etc. can be presented for associating the respective parts contained the images acquired in time-series.

The tracking input unit 101, in the case of tracking the hand position by use of the methods described above, can select and narrow down an image field under such several conditions that a tracking target part contained in the captured image is, e.g., tinged with a skin color and is moving at a predetermined or higher velocity but is not a face as well as being checked against a hand characteristic dictionary. The tracking input unit 101 narrows down the image captured in time-series by the camera 14a etc. under the condition described above or with a combination of the plurality of conditions, thus tracking the hand position of the user. Note that a method of determining whether the captured image contains the face or not, can be exemplified by a Viola-Johns Face Detection algorithm. Further, the hand characteristic dictionary is a characteristic table registered with some number of characteristic vectors extracted from the variety of captured images of the user's hand, which are contained in the captured images acquired through the camera 14a etc. For example, the captured image is segmented in lattice within a fixed area, then gradient histograms of outline components of the tracking target part are taken from within the respective areas after being segmented, and HOG (Histograms of Oriented Gradients) characteristics characterizing the tracking target part as multidimensional vectors can be exemplified by way of characteristic vectors.

The tracking input processing unit 101 takes, in the case of using the hand characteristic dictionary, e.g. the gradient histograms of the outline components associated with the user's hand as the tracking target part on the basis of the captured images acquired in time-series the camera 14a etc., and may previously register the gradient histograms as the characteristic vectors in the hand characteristic dictionary.

Moreover, the image capturing device to capture the image of the operation part of the user of the motion input apparatus 10 can involve using, e.g., an image receiving apparatus with a depth value, the apparatus being capable of acquiring a depth up to the object. This type of image receiving apparatus with the depth value can be exemplified by a TOF (Time Of Flight) method using infrared-rays etc., an infrared pattern distortion analyzing method implemented in Kinect (registered trademark) of Microsoft Corp., a stereo matching method and so on. The stereo matching method provides, e.g., at least two or more image capturing devices, matches images captured by the respective image capturing devices, and is thereby enabled to estimate a depth of an image capturing target object from a positional deviation of the same object contained in the respective captured images.

The motion input apparatus 10 can obtain 3-dimensional information of the user by acquiring a depth value of the target object by the method described above and is therefore capable of enhancing the positional accuracy in the case of tracking the hand position from the 2-dimensional information. For example, the motion input apparatus 10 estimates a position of the user's arm from the images captured in time-series, and specifies a distal end part of the arm in the estimated position as a position of the hand. For instance, the arm part of the user takes a rod-like shape on the image with the depth value. It may be sufficient that the motion input apparatus 10 specifies the distal end part of the rod-like object, e.g., from a depth difference between a minimum point and a periphery of the minimum point within the captured image containing the arm part. The motion input apparatus 10 detects a region exhibiting a large depth difference with respect to exclusive of one direction or all directions in the periphery of the minimum point contained in the captured image, and can set this detected region as the distal end part.

Note that a plurality of such minimum points may be contained in the captured image. For example, it may be sufficient that the motion input apparatus 10 previously specifies the plurality of minimum points on the captured image when in the operation invalid status as tracking target candidate points, and reflects the point exhibiting the highest moving velocity in a motion of the cursor in the invalid operation status. This is because the moving velocity of the position of the user's hand is relatively higher than the arm part in the captured image.

Further, the motion input apparatus 10 may allocate the cursors to a plurality of tracking target candidate points each exceeding a predetermined velocity, which are contained in the captured image, and may also simultaneously display the respective cursors on the LCD 15a etc. It is because the user can quickly find out the cursor moving to follow an operational intention of the user from within the plurality of cursors displayed simultaneously on the LCD 15a. Then, it may be sufficient that the motion input apparatus 10 specify, as the tracking target, the tracking target candidate point useful for the operation for a shift when shifting to the operation valid status from within the plurality of tracking target candidate points. The motion input apparatus 10 may also, in the case of displaying the plurality of cursors, e.g. change a display mode whenever displaying each cursor. The user distinguishes a display position of the cursor related to the operation from within the plurality of cursors on the screens displayed for different display targets, and can select this cursor as the cursor related to the operation.

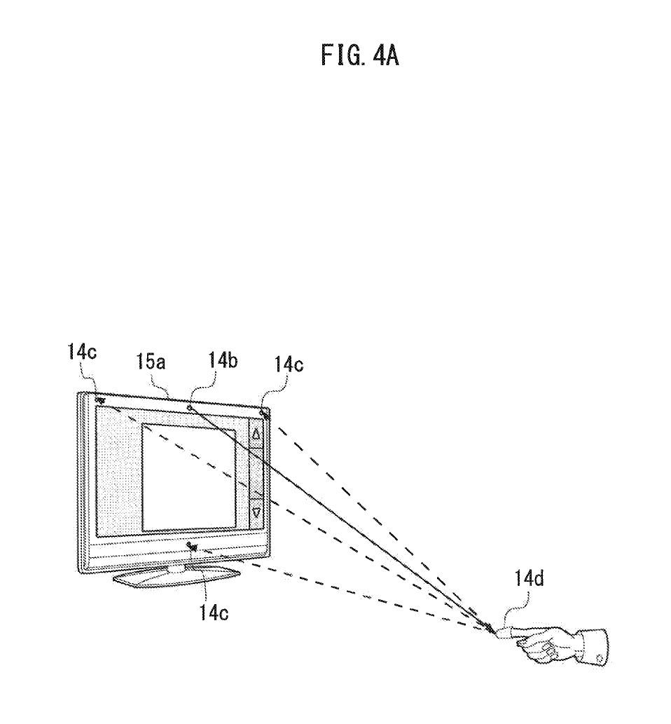

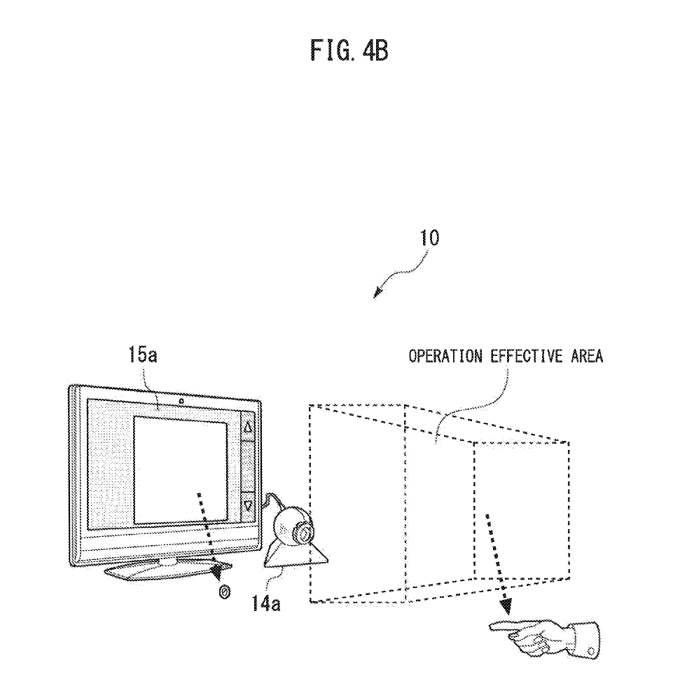

Note that the following discussion describes the user's hand as the tracking target of the motion input apparatus 10, however, as far as any problem in terms of the operation does not arise, an object held by the hand, an object attached to the body or another different part of the body may also be tracked. FIG. 4A illustrates an explanatory diagram of a tracking example using infrared rays etc. In the example of FIG. 4A, an LED 14b irradiates the user facing the LCD 15a with the infrared rays etc. The infrared rays etc. irradiated from the LED 14b are reflected by a fitting object 14d fitted to a tracking target finger etc. of the user and are detected by, e.g., a plurality of photo detectors 14c provided in a holding frame for the LCD 15a etc. The motion input apparatus 10 obtains, e.g., a distance value from the fitting object 14d on the basis of the infrared rays detected by the plurality of photo detectors 14c and can detect a position of the fitting object by triangulation etc. Note that the fitting object 14d may be configured to have a light emitter such as the LED as a substitute for the LED 14b in the explanatory diagram of FIG. 4A. It may be sufficient that the plurality of photo detectors 14c provided in the holding frame for the LCD 15a etc. detects the infrared rays etc. irradiated from the fitting object 14d, and the motion input apparatus 10 detects the position of the fitting object by the triangulation etc. In the example of FIG. 4A, the infrared rays are one example, and electromagnetic waves used for, e.g., NFC (Near Field Communication) may also be utilized.

Furthermore, the tracking input unit 101 may also detect the face and a line of sight of the user, and track the detected face and the detected line of sight of the user. If tracking accuracy is sufficiently high, a forefinger of the user may also be tracked. Furthermore, the hand wearing a glove having a specific pattern, color, etc. may also be tracked by making use of a color profile etc. of the captured image. Moreover, what is applied to the mode switchover from the invalid status to the valid status of the non-contact type UI function may be not the detection of the spatial position of the operation based on the motion input during, e.g., the invalid mode but the detection of an operation position of a contact type pointing device such as a mouse and a trackball.

The invalid condition determining unit 102 determines whether or not, e.g., a position and a motion of the hand, which are detected by the tracking input unit 101, satisfy a condition for shifting the status of the non-contact type UI function to the invalid mode from the valid mode. The invalid condition determining unit 102 detects the user's motion input satisfying the predetermined condition when the operation status about the non-contact type UI function of the motion input apparatus 10 is valid, the operation status being retained by the status retaining unit 104. Then, the motion input apparatus 10 performs the mode switchover of the status of the non-contact type UI function from the valid status to the invalid status, thus shifting to the invalid mode. Note that the mode switchover condition from the valid status to the invalid status of the non-contact type UI function has no limit in the motion input apparatus 10 according to the embodiment.

The mode switchover condition for shifting to the invalid mode when in the valid mode can be exemplified by an event that the tracking position of the operation part of the user, which is detected by the tracking input unit 101, deviates from a predetermined area over a predetermined period of time. Herein, the “predetermined area” can be set as a partial area in a spatial image capturing area defined by a view angle etc. of the image capturing device such as the camera 14a. Further, this predetermined area will hereinafter be called an operation effective area.

FIG. 4B illustrates an explanatory diagram of the operation effective area. In the explanatory example of FIG. 4B, the user performing the operation based on the user's motion input positions himself or herself to face the LCD 15a etc. on which to display the cursor while facing the image capturing device such as the camera 14a. The camera 14a etc. covers an image capturing area to capture an image of the user performing the motion input related to the operation in the space on the side of the user in a face-to-face position. The user facing the camera 14a and the LCD 15a conducts the motion input related to the operation by moving the operation part within the image capturing area. When the user's hand is set as the operation part of the motion input related to the operation, the operation effective area has a relationship given by, e.g., Image Capturing Area>Tracking Range≧Operation Effective Area. Namely, the image capturing area embraces the tracking range, and the tracking range embraces the operation effective area. Herein, the tracking range can be defined as a movable range of the position of the user's hand within the image capturing area. The motion input apparatus 10 executes a process for the operation input related to the operation in the way of being associated with the position of the user's hand moving in the tracking range within the image capturing area.

In the explanatory example of FIG. 4B, the motion input apparatus 10 may also define the tracking range in the way of being associated with a position of the user's body within the image being captured and a moving range of the cursor within an image display area of the LCD 15a etc. Then, the motion input apparatus 10 may also set the operation effective area in the tracking range.

The tracking range in FIG. 4B can cover, e.g., an area ranging, in a depthwise direction, to the position of the user from a position closer to the camera, the position being ten and several centimeters away from the front (toward the camera) of the user taking the face-to-face relationship with the camera 14a and the LCD 15a. Then, in the explanatory example of FIG. 4B, for instance, a rectangular parallelepiped area associated with the cursor moving range in the image display area of the LCD 15a etc. can be set as the operation effective area. Note that the operation effective area within the image capturing area can be configured as an approximately 1.5-fold rectangular parallelepiped area in actual dimensions against the cursor moving range in the image display area of the LCD 15a etc. This is because the area of the LCD 15a is slightly narrower than the image capturing area in the example of FIG. 4B.

The invalid condition determining unit 102 can make it a condition for the switchover to the invalid status that the position of the operation part of the user performing the motion input continues to exist, as illustrated in, e.g., FIG. 4B, beyond the operation effective area for a predetermined or longer period of time. Further, the invalid condition determining unit 102 can make it the condition for the switchover to the operation invalid status that the position of the user's hand within the effective area continues to be in a state of touching a body part such as a head, a chin and a chest of the user over a predetermined period of time. Still further, the invalid condition determining unit 102 can make it the condition for the switchover to the operation invalid status that, e.g., the direction of the line of sight or the direction of the face, if the direction of the line of sight or the direction of the face are targeted, are not oriented toward the display screen of the LCD 15a over a predetermined period of time. Note that the condition for switchover from the valid status to the invalid status of the non-contact type UI function may involve that the invalid condition determining unit 102 detects a specific hand sign, a specific moving trajectory of the hand and occurrence of a specific voice. For example, the invalid condition determining unit 102 can set, as the condition for the switchover to the invalid status, each of a motion of directing a palm toward the camera 14a in a state of the fingers being closed, a motion of moving the hand in a Z-like shape and an utterance action of uttering a specific keyword.

Moreover, the invalid condition determining unit 102 may also make it the condition for the switchover to the invalid status that the position of the cursor moving while being associated with the position of the user's hand within the operation effective area passes through a plurality of specific regions within the image display area of the LCD 15a etc. in a predetermined period of time. For instance, the invalid condition determining unit 102 can make it the condition for the switchover to the invalid status that the cursor moving while being associated with the position of the user's hand within the operation effective area passes through three corners of four corners of the screen display area in the predetermined period of time.

Referring back to the explanatory diagram illustrated in FIG. 3, the invalid status control unit 103 switches over the status of the non-contact type UI function from the valid status to the invalid status on the basis of, e.g., a result of the determination made by the invalid condition determining unit 102. For example, the status retaining unit 104 is notified of the status of the non-contact type UI function, the status being switched over by the invalid status control unit 103.

The status retaining unit 104 retains, e.g., the valid status and the invalid status of the non-contact type UI function, these statuses being switched over by the invalid status control unit 103 and the valid status control unit 105. For instance, the status retaining unit 104 can set a status value “1” in the valid status and a status value “0” in the invalid status. The status retaining unit 104 temporarily stores, in a predetermined area of the main storage unit 12, the 1-bit binary status value exemplified such as “0” and “1” corresponding to the statuses of the non-contact type UI function, which are switched over by the invalid status control unit 103 and the valid status control unit 105.

Note that the motion input apparatus 10 according to the embodiment tracks the position of the user's hand from the images captured in time-series by the camera 14a irrespective of the valid or invalid status of the non-contact type UI function. Then, the motion input apparatus 10 updates the display position of the cursor on the LCD 15a, corresponding to the tracked position of the user's hand. When the non-contact type UI function is in the invalid status, however, there is invalidated the instruction operation on the UI object, the instruction operation based on the motion input via the camera 14a etc. It is therefore desirable that a display mode of the cursor displayed on the LCD 15a etc. is distinguished corresponding to, e.g., the status of the non-contact type UI function, the status being retained by the status retaining unit 104. For example, the motion input apparatus 10 can differentiate a shape of the cursor when the non-contact type UI function status retained by the status retaining unit 104 is invalid from a shape of the cursor when in the valid status. Moreover, the motion input apparatus 10 can take, as the display mode of the cursor in the invalid status, any one of, e.g., the outline alone, semi-transparency, a meshed form and gray-out in coloring of the display cursor or a combination thereof. In any of these cases, it is desirable that the motion input apparatus 10 takes the display mode to make inconspicuous the cursor in the invalid status in comparison with the display mode of the cursor displayed when in the valid status of the non-contact type UI function.

The valid status control unit 105, e.g., if the predetermined condition is satisfied by the position etc. of the user's hand that is detected when in the invalid status of the non-contact type UI function, switches over the mode to shift the status of the non-contact type UI function to the valid status. The valid status control unit 105 notifies the status retaining unit 104 that the non-contact type UI function is in the valid status, e.g., after switching over the mode.

The valid status control unit 105, for instance, can make it the condition for switching over the mode that a count value of the motion inputs deemed to be the operations on the UI object, the count value being counted by the UI operation counting unit 106, is equal to or larger than a predetermined value.

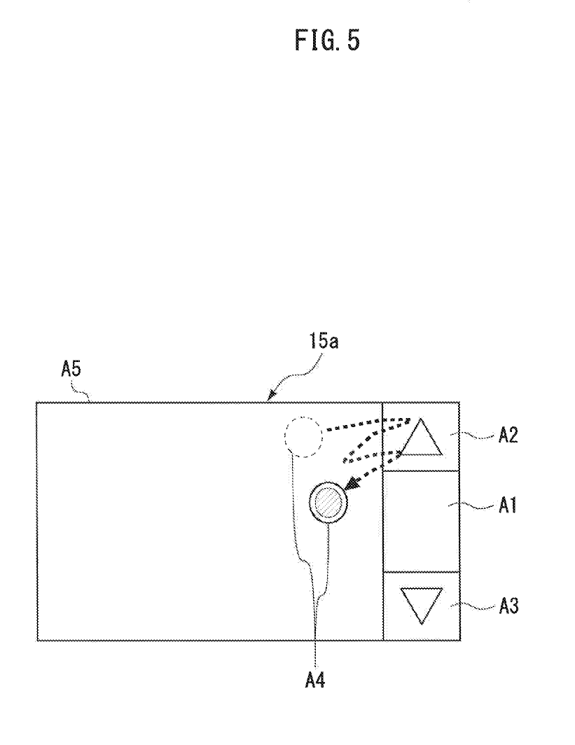

FIG. 5 illustrates an explanatory diagram of an operation method using “crossing” as an operation method for the UI object when the non-contact type UI function is in the valid status. In the explanatory diagram depicted in FIG. 5, a display area A5 is a display area for displaying the image information on the LCD 15a, the operation component etc. such as the UI object illustrated in FIG. 1. A scroll bar provided in a display area A1, operation buttons provided in display areas A2, A3 and a cursor provided in a display position A4, are displayed within the display area A5. The cursor in the display position A4 moves within the display area A5 in a way that corresponds to the movement of the motion part related to the motion input of the user. In the explanatory example of FIG. 5, the motion input apparatus 10 shifts to the valid status, the shift being triggered by such an event that a predetermined number of operations on the UI object when in the invalid status are conducted within a predetermined period of time.

The “crossing” is, e.g., a method for selecting and operating the operation target due to the cursor passing in a predetermined direction and in a predetermined sequence over borderlines of the display areas for the UI objects etc. displayed on the display screen of the LCD 15a.

In the explanatory example illustrated in FIG. 5, the user performing the motion input executes a selective operation of an upper scroll of the image information displayed in the display area A5 by manipulating the cursor displayed in the display position A4 to cross over the borderline of the operation button in the display area A2. In the crossing in the illustrated example, the cursor, after moving from outside the display area A2 into this area, repeats exiting the area, then moving from outside the area again into the area and further moving outside the area from within the area, thereby switching over the mode.

For example, the UI operation counting unit 106 counts the number of motions deemed to be the operations on the UI object through the cursor moving in the way of being associated with the motion input of the user. In the explanatory example of FIG. 5, a cursor moving operation for the cursor to cross over a display borderline of the operation button displayed in the display area A2 and to, after moving into the area from outside the area, move again outside the area, corresponds to a motion deemed to be the operation on the operation button.

The valid status control unit 105 compares, e.g., a count value of the number of motions deemed to the operations on the UI objects with a threshold value, the count value being counted by the UI operation counting unit 106. Then, the valid status control unit 105, if the count value is equal to or larger than the threshold value, switches over (restores) the status of the non-contact type UI function of the motion input apparatus 10 to the operation valid status from the invalid status. The explanatory example of FIG. 5 is a case of switching over to the valid status if such a cursor moving operation is repeated twice or more as to, across over the display borderline of the operation button displayed in the display area A2, move into the area from outside the area and move again outside the area.

As depicted in FIG. 5, it is desirable to change the display mode of the cursor so that the mode being switched over can be clarified to the user when the status of the non-contact type UI function shifts to the valid status from the invalid status as illustrated in FIG. 5. For example, the cursor indicated by a circle of a dotted line represents a display position in the invalid status, while the cursor indicated by a blotted-out circle represents a display position of the cursor in the valid status after switching over the mode.

Note that a threshold value for switching over the status of the non-contact type UI function may be set, e.g., per UI object displayed on the LCD 15a or per type of the UI object. Convenience related to the switchover operation can be improved by setting the threshold value per UI object or per type of the UI object displayed within the display area of the LCD 15a etc.

Further, as for the UI objects displayed on the LCD 15a etc., if being the UI object not being frequently operated without any intention, the motion input apparatus 10 may set “0” or “1” as the threshold value for switching over the status of the non-contact type UI function. It is because when detecting the motion input related to the operation on the UI object not being frequently operated without any intention, the motion input apparatus 10 can determine that the user is in the process of performing the operation on the UI object displayed on the LCD 15a etc. with an operational intention of the user.

If “0” is set as the threshold value for switching over the status of the non-contact type UI function, the status of the non-contact type UI function can be switched over to the valid status due to the detection of the motion input related to the operation on the target UI object. Then, the motion input apparatus 10 can execute a predetermined function associated with the target UI object, e.g., can execute switching over the display screen, scrolling the display area on the screen, and so on. Namely, if “0” is set as the threshold value for switching over the status of the non-contact type UI function, the motion input apparatus 10 is capable of the motion input about the UI object displayed on the LCD 15a etc. similarly to the valid status even when the non-contact type UI function is in the invalid status.

The valid status control unit 105 can set, as the condition for switching over the mode, e.g. a detection of the operations based on the continuous motion inputs about a single UI object displayed on the LCD 15a etc. Such a case is assumed under this condition that the detected motion inputs contain, e.g., motions not related to the continuous operations about the UI object. Herein, the “motions not related to the continuous operations” are motions extending over a plurality of UI objects and motions not defined as simple reciprocating movements, or redundant motions. To handle such a case, the valid status control unit 105, e.g., if detecting the motions not related to the continuous operations about the UI object, may execute setting not to satisfy the condition for switching over the mode even when a predetermined operation count is detected within the predetermined period of time.

Note that when the user performs the plurality of continuous operations on the single UI object displayed on the LCD 15a etc., the first operation and an arbitrary n-th operation tend to take similar motions. The motion input apparatus 10 may detect a dissimilarity in motion between the operations on the UI object, e.g., by matching motion patterns of the motion inputs related to the operations of the respective times on the basis of the images captured in time-series by the camera 14a etc. For example, a DP (Dynamic Programming) matching method is exemplified as a pattern matching method related to the motion of the motion input on the basis of the captured images acquired in time-series. The motion input apparatus 10 detects the dissimilarity in motion between the motion inputs pertaining to the operations by using, e.g., the DP matching method etc., thereby enabling a detection of an irregular motion in the reciprocating movements of the motion inputs about the UI object.

Moreover, the valid status control unit 105 can set, as the conditions for switching over the mode, e.g. the direction of the face and the direction of the line of sight of the user when inputting the motion in addition to the detection of the operation based on the motion input about the UI object displayed on the LCD 15a etc. described above. For instance, the motion input apparatus 10 is provided with a face detection unit to detect the user's face from the time-series captured images or a line-of-sight detection unit to detect the line of sight of the user from the time-series captured images. Then, the tracking input unit 101 of the motion input apparatus 10 specifies based on the detected face and the line of sight of the user that the tracked direction of the face and the tracked direction of the line of sight are not oriented toward the LCD 15a etc. on which to display the UI object. Then, the valid status control unit 105 may not conduct the mode switchover to the valid status if the direction of the face and the direction of the line of sight of the user are not oriented toward the LCD 15a etc. on which to display the UI object.

Further, similarly, when the valid status control unit 105 detects the operation based on the motion input about the UI object, the tracking input unit 101 specifies the detected direction of the face and the detected line of sight of the user. Then, for instance, whereas if the identified direction of the face and the identified direction of the line of sight of the user are oriented toward the LCD 15a etc. on which to display the UI object, it may be sufficient that the valid status control unit 105 makes a determination as to validity of the operation based on the motion input and switches over the mode. The motion input apparatus 10 includes the direction of the face and the direction of the line of sight of the user performing the operation based on the motion input with respect to the UI object in the determination condition for switching over the mode, thereby enabling enhancement of determination accuracy to switch over the mode.

The UI operation counting unit 106 determines based on, e.g., a result of the determination made by the UI operation determining unit 107 whether or not the operation based on the detected motion input is deemed to be the operation on the UI object displayed on the LCD 15a etc. Then, the UI operation counting unit 106 counts a detection count of the operations based on the motion inputs deemed to be the operations on the UI object within the predetermined period of time. For example, the valid status control unit 105 is notified of a count value counted by the UI operation counting unit 106.

The UI operation counting unit 106, if the operation based on the detected motion input is deemed to be the operation on the UI object displayed on the LCD 15a etc., temporarily stores, e.g., history information representing this purport together with time information in a predetermined area of the main storage unit 12. The history information can be exemplified by, e.g., a flag indicating that the operation based on the detected motion input is the operation on the UI object displayed on the LCD 15a etc.

The UI operation counting unit 106 stores “1” in the flag, which indicates the operation on, e.g., the UI object, and further stores this history information together with the time information in the predetermined area of the main storage unit 12. The UI operation counting unit 106, for instance, whenever detecting the operation based on the motion input deemed to be the operation on the UI object displayed on the LCD 15a etc., accumulates the flag defined as the history information in the predetermined area of the main storage unit 12. Then, it may be sufficient that the UI operation counting unit 106, each time the flag is set up, traces the history information accumulated in the main storage unit 12 back to a point of a predetermined time and counts the number of flags (flag count). The history information accumulated before the predetermined time in the main storage unit 12 may be deleted.

Furthermore, the UI operation counting unit 106, for example, if the operation based on the detected motion input is deemed to be the operation on the UI object displayed on the LCD 15a etc., may start up a timer set at the fixed time. The UI operation counting unit 106 may also count the number of operations based on the motion inputs deemed to be the operations on the UI object during the timer period of the timer started up.

The UI operation determining unit 107 determines the operation on the basis of, e.g., a movement of the cursor associated with the hand motion detected by the tracking input unit 101, a state of the UI object displayed on the LCD 15a etc. and a positional relationship between the cursor and the UI object. The operation determination made by the UI operation determining unit 107 involves determining how the operation on the UI object displayed on the LCD 15a etc. is conducted. Note that the UI operation determining unit 107 may include a depthwise motion of the position of the hand, a shape of the hand, the direction of the face, the direction of the line of sight, etc., which are detected by the tracking input unit 101, in the condition for determining the operation. For example, the UI operation processing unit 108 is notified of a result of the determination of the operation on the UI object, the determination being made by the UI operation determining unit 107.

As illustrated in FIG. 5, the crossing-based method can be exemplified as the operation method about the UI object displayed on the LCD 15a etc. The crossing-based method includes detecting, e.g., that the cursors moving in the way of being associated with the operation based on the motion input of the user passes in a predetermined direction and in a predetermined sequence over the borderlines of the display areas for the UI objects etc. displayed on the screen, and selecting and operating the operation target.

In the case of not using the non-contact type UI function, for instance, the user superposes the cursor on the display position of the button component on the screen by operating the pointing device such as the mouse and then clicks the cursor, thus depressing the button component. A general type of computer detects the button depression by the user, and executes an application function associated with the depression. On the other hand, the crossing is that the motion input apparatus 10, e.g., detects that the cursor moving in the display area on the screen corresponding to the operation based on the motion input moves into the area from outside the area over the border of the display area of the button component, and executes an application function associated with depressing the button component.

The depression on the button component according to the crossing may involve combining, as illustrated in FIG. 5, the cursor movement into the area from outside the area where the button component is displayed with the consecutive cursor movement toward the outside of the area from within the area. The UI operation determining unit 107 may make it a condition for determining the depression that the display position of the cursor moving in the display area on the screen corresponding to the motion input related to the operation consecutively passes over the border of the display area for the button component. Furthermore, when the UI object is the scroll bar, the UI operation determining unit 107 detects, e.g., that the display position of the cursor moves into the display area from outside the display area over the border of the display area of the scroll bar, and may display an operation component such as a water turbine to rotate corresponding to a scroll quantity of the display area. The user can increase or decrease the scroll quantity of the display area by, e.g., adjusting a rotation quantity of the operation component such as the water turbine displayed thereon through the consecutive crossing.

The determination of the operation on the UI object, which is made by the UI operation determining unit 107, may involve, e.g., calculating a degree of how much the operation is deemed to be the operation on the UI object, counting the operations each having the degree equal to or larger than a predetermined value and thus making a quantitative determination of the operation. The quantitative determination of the operation being thus carried out, it is feasible to estimate how much of certainty the operation based on the detected motion input occurs with, and hence the motion input apparatus 10 can reduce the mode switchover to the valid status due to, e.g., an accidental motion input not intended by the user.

It may be sufficient that the motion input apparatus 10, e.g., previously measures the operation based on the motion input of the user on the UI object, attains clustering, averaging, distributing, etc. of the pattern groups of the measured operations based on the motion inputs and configures a database (DB) of standard UI object operation patterns. Each UI object operation pattern includes, e.g., an operation trajectory related to the operation on the UI object, a profile of the operation trajectory, etc. Then, it may be sufficient that the UI operation determining unit 107 of the motion input apparatus 10 checks the operation based on the detected motion input against the UI object operation patterns registered in the DB and obtains the degree of the operation deemed to be the operation on the UI object.

Note that the degree of the operation deemed to be the operation on the UI object may also be obtained by checking against, e.g., a heuristic condition based on an empirical rule other than the determinations based on the actual measurement and the statistics described above. The motion input apparatus 10 can reflect a condition based on the empirical rule such as “decreasing the degree of the operational certainty if crossing on the button via a zig-zag trajectory (non-linear trajectory)” in the operation based on the motion input.

The UI operation processing unit 108, e.g., when the non-contact type UI function is in the valid status, executes the function associated with the operation target UI object indicated by the cursor etc. on the basis of the determination result notified from the UI operation determining unit 107. For example, in the case where a started-up application is a moving picture viewer, when the operation based on the motion input on a playback button displayed on the screen is determined to be a depression on the playback button, a view target moving picture is played back. Further, e.g., in the case where the started-up application is a browser, when the operation based on the motion input is determined to be the operation on the scroll bar displayed on the screen, the display area of a content being now displayed is scrolled via the browser.

Note that the UI operation processing unit 108 processes, as a valid operation, the operation based on the motion input on the UI object of the first time immediately after switching over the mode of the non-contact type UI function to the valid status from the invalid status. Then, the UI operation processing unit 108 may process, as an invalid operation, each of the operations, from the second time onward, based on the detected motion inputs during a period since when switching over the mode till a predetermined period of time elapses. The motion input apparatus 10 is capable of restraining a process for, e.g., an extra motion input occurring excessively just after the mode switchover by giving timewise redundancy to the operation based on the motion input immediately after the mode switchover.

The cursor control unit 109 updates the display position of the cursor displayed on the LCD 15a etc. in accordance with, e.g., the positional information of the operation part of the motion input of the user, the motion input being related to the operation detected by the tracking input unit 101. The cursor control unit 109 associates, e.g., the positional information of the operation part of the motion input related to the operation in the operation effective area, the operation being detected by the tracking input unit 101, with the positional information of the cursor moving in the display area of the LCD 15a etc. The cursor control unit 109 notifies the screen display unit 110 of the positional information of the cursor, which is associated with the positional information of the operation part of the motion input related to the operation.

The positional information of the cursor is associated with the positional information of the operation part of the motion input related to the operation through, e.g., affine transformation of coordinate information of the operation part of which the image is captured by the camera 14a etc. and coordinate information on the display screen for the cursor. The user executing the motion input related to the operation faces the image capturing device such as the camera 14a to capture, e.g., the image of the motion input. The motion input apparatus 10 performs, e.g., calibration to align a central position of a movable range of the operation part related to the motion input of the user with a central position of a display coordinate system of the LCD 15a etc. Then, it may be sufficient that the motion input apparatus 10 perform coordinate transformation so that a coordinate system of a height, a width, etc. of the movable range of the operation part is associated with a display coordinate system of the LCD 15a etc. while keeping an aspect ratio, these two coordinate systems being aligned after, e.g., the calibration. Note that if ratios of the height, the width, etc. in the display coordinate system of the LCD 15a etc. on which to display the cursor are different from those in the coordinate system of the operation part, it may be sufficient that, for instance, the transformation in each coordinate system is conducted based on the smaller in terms of a scaling ratio with respect to the hight, the width, etc.

The screen display unit 110 displays, e.g., the screen for the application, displays the UI object, displays the cursor moving on the display screen corresponding to the detected motion input of the user, and so on, which can be all operated by use of the non-contact type UI function. The screen display unit 110 displays the cursor on the LCD 15a etc. on the basis of, e.g., the positional information notified from the cursor control unit 109. Note that display contents of the application screen and the UI object, which are displayed on the LCD 15a etc., are arbitrary corresponding to the target application etc. but are not limited in any way.

For example, a display shape of the cursor can be exemplified by an arrow shape, a cross shape and a pointer shape. Moreover, the application screen displayed on the LCD 15a etc. can be exemplified by a Web browser screen, a moving picture viewer screen, an image viewer screen, and so forth. The UI object can be exemplified by the operation button, the scroll bar and so on.

Note that when operating the UI object by use of the non-contact type UI function, unlike a device contact type operation of the UI object using a mouse etc., it is unfeasible to employ an explicit trigger on the premise of the device contact type operation such as “click” and “drag”. Therefore, except the crossing described with respect to the UI operation determining unit 107, for example, a depthwise movement of the hand, a change to a specific hand sign, a stay of the cursor in the display area for the operation target UI object, etc. may be each deemed as the explicit trigger in the device contact type operation.

Further, the screen display unit 110 may display one or plural dedicated UI objects provided for restoring to the valid status when in the invalid status. For example, the cursor passes a predetermined number of times within the predetermined period of time through the display areas of the plurality of UI objects displayed on the screen sequentially, and the valid status control unit 105 is thereby enabled to switch over the status to the valid status.

### [Processing Flow]

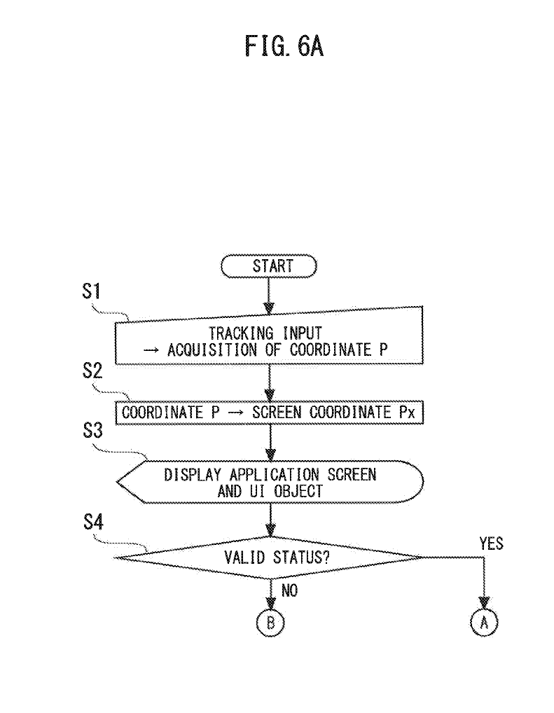

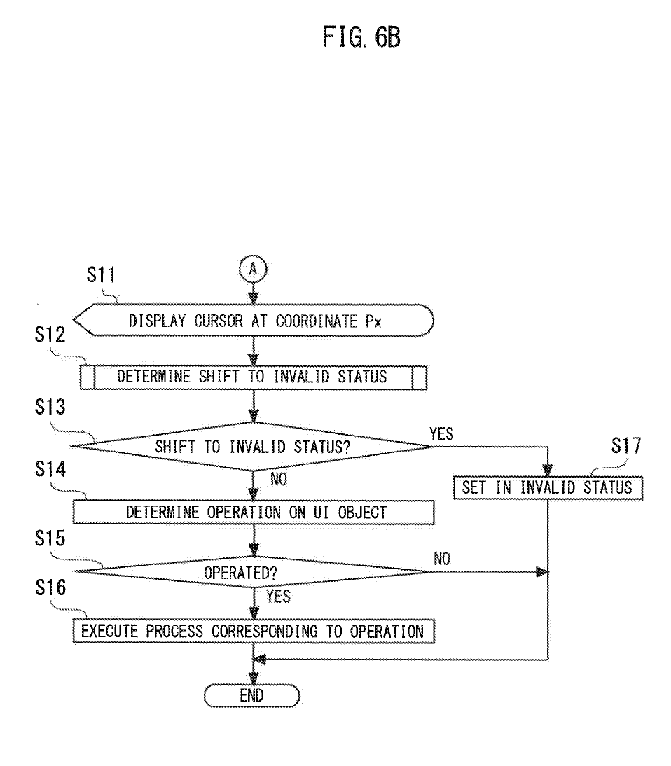

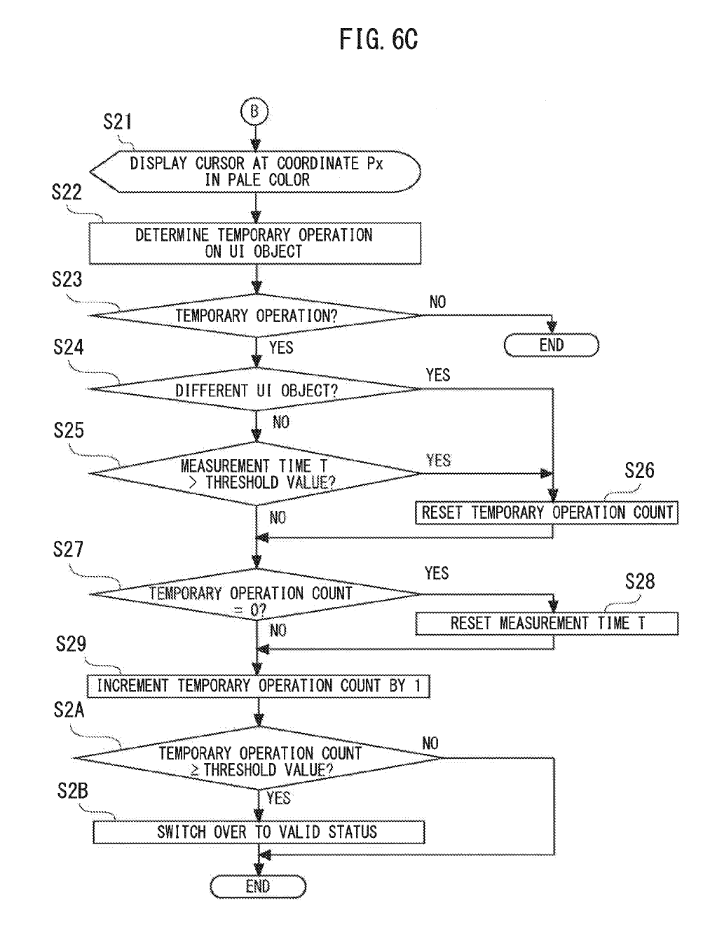

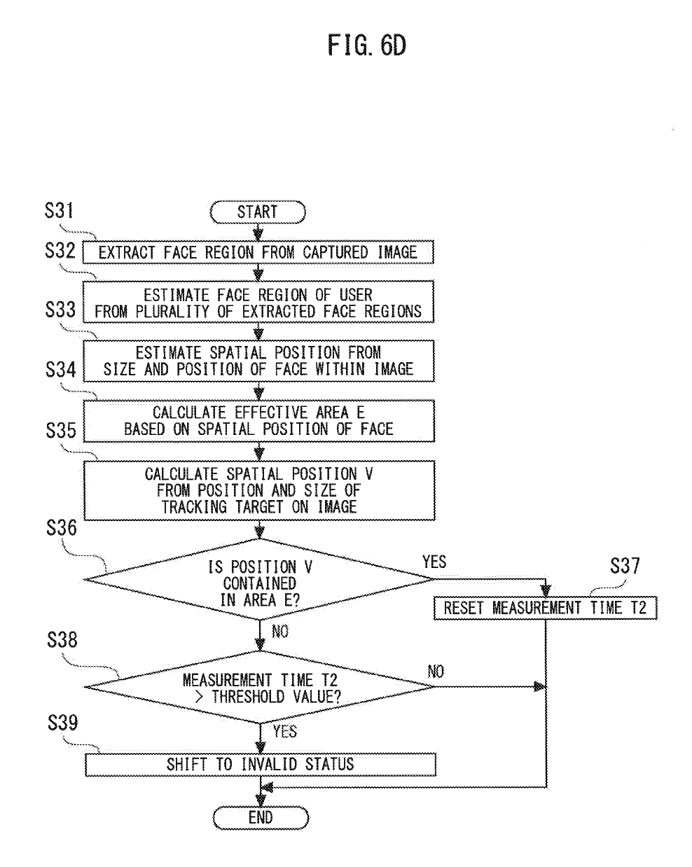

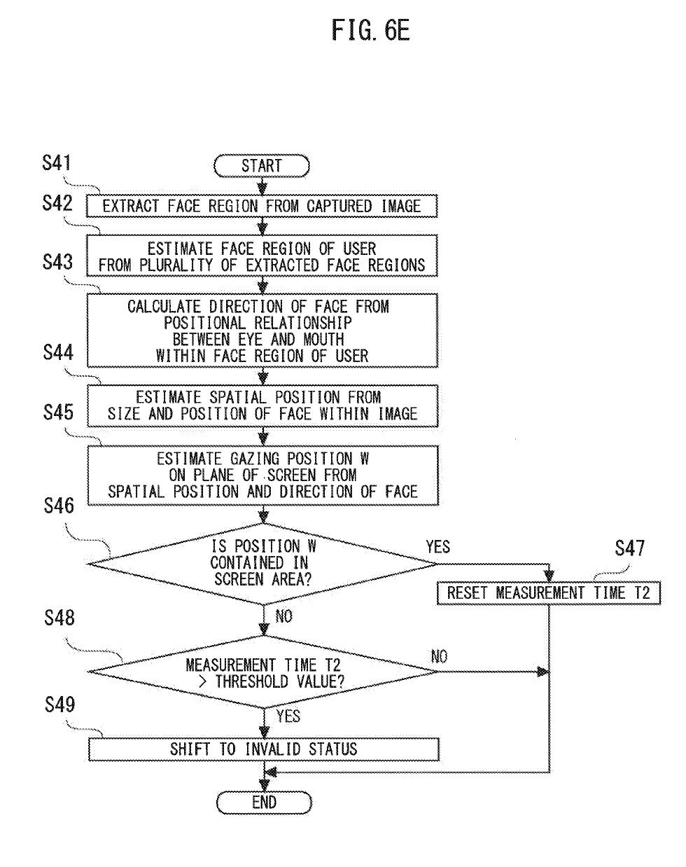

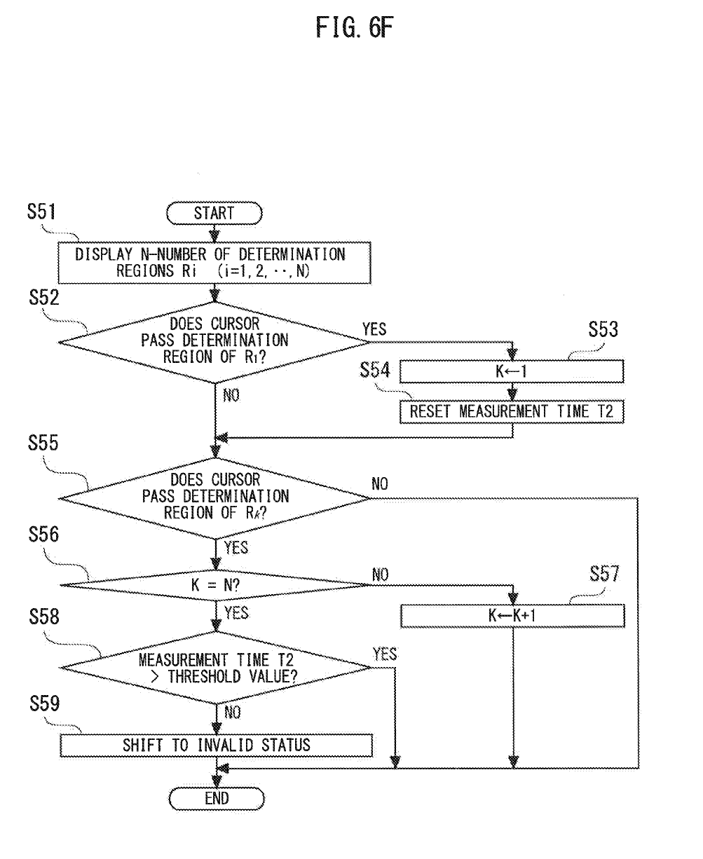

A mode switchover process of the motion input apparatus 10 according to the embodiment will hereinafter be described with reference to FIGS. 6A-6F. FIGS. 6A-6F illustrate flowcharts of the mode switchover process for the operation based on the motion input of the user in the motion input apparatus 10. The motion input apparatus 10 executes the mode switchover process illustrated in FIGS. 6A-6F through, e.g., a computer program deployed in an executable manner on the main storage unit 12. Incidentally, it is assumed that the operation target application screen of the user, the UI object, etc. are to be displayed on the display screen of the LCD 15a etc. of the motion input apparatus 10 in the following discussion.

In the flowchart illustrated in FIG. 6A, a trigger to start the mode switchover process is exemplified by when inputting the captured image through the image capturing device such as the camera 14a or when making a start to invoke the process at a time interval of, e.g., 1/30 sec. The motion input apparatus 10, as triggered by occurrence of the event described above, executes the mode switchover process in the embodiment.

In the flowchart depicted in FIG. 6A, the motion input apparatus 10 acquires the positional information by, e.g., grasping the operation part such as the user's hand serving as the tracking target of the motion input related to the operation from the time-series of the images captured by the camera 14a etc. (S1). The positional information of the tracking target is, e.g., expressed as a 2-dimensional coordinate P indicated by (X, Y), in which a direction along a Y-axis defines a vertical direction with respect to the user facing the camera 14a, and a direction along an X-axis defines a horizontal direction. Note that the positional information is, if a depth of the image is acquired as by the stereo matching and the ToF as described in relation to the tracking input unit 101 in FIG. 3, expressed as a 3-dimensional coordinate with the Z-axis direction defining the direction of the user facing the camera 14a. The motion input apparatus 10 temporarily stores the coordinate information of the tracking target in, e.g., a predetermined area of the main storage unit 12.

The motion input apparatus 10 transforms the coordinate P acquired in the process of S1 and representing the position of the tracking target into, e.g., a screen coordinate Px representing the position of the cursor moving in the display area of the LCD 15a etc. (S2). The coordinate transformation of the coordinate P representing the position of the tracking target into the screen coordinate Px representing the cursor position has already been described in relation to the cursor control unit 109 in FIG. 3. Note that if the coordinate P acquired in the process of S1 is the 3-dimensional coordinate, the motion input apparatus 10 can transform a coordinate of the position on the captured image into a coordinate in a real space by use of a distance up to the tracking target. As the image capturing device is distanced farther from the tracking target, a variation of the coordinate of the position of the tracking target on the captured image tends to become smaller due to, e.g., a perspective drawing even when a moving quantity remains unchanged. The motion input apparatus 10 transforms the coordinate P acquired as the 3-dimensional coordinate into the coordinate in the real space and is thereby enabled to reflect the moving quantity of the tracking target moving on the display screen corresponding to the motion input of the user in a moving quantity of the cursor without depending on, e.g., the distance from the image capturing device. Hence, the convenience and usability of the motion input apparatus 10 can be improved owing to the transformation into the coordinate in the real space from the coordinate of the position on the captured image.

The motion input apparatus 10 executes, e.g., an update process of the application screen, the UI object, etc., which are displayed on the LCD 15a etc. (S3), and determines whether the operation mode at the present is in the valid status or not (S4). The motion input apparatus 10 determines a status of the operation mode at the present on the basis of the status of the non-contact type UI function, the status being retained by the status retaining unit 104. The motion input apparatus 10 advances to S11 if the operation mode at the present is in the valid status (S4, YES) as a result of the determination process in S4, and executes the mode switchover process (S11-S16) when in the valid status. The motion input apparatus 10 diverts to S21 whereas if the operation mode at the present is not in the valid status (S4, NO) as the result of the determination process in S4, and executes the mode switchover process (S21-S2B) when in the invalid status. Note that the update process in S3 may be executed between, e.g., the processes in S1-S2 and may also be executed after the determination process in S4 when the respective items of display information displayed on the LCD 15a etc. are properly updated.

Herein, the process in S1 executed by the motion input apparatus 10 is one example of acquiring a position of a motion part related to a motion input of a user. Further, the CPU 11 etc. of the motion input apparatus 10 executes the process in S1 by way of one example to acquire the position of the motion part related to the motion input of the user.

FIG. 6B illustrates a flowchart of the mode switchover process when the non-contact type UI function is in the valid status. In the flowchart illustrated in FIG. 6B, the motion input apparatus 10 displays the cursor positioned in the position coordinate Px on the display screen of the LCD 15a etc. on the basis of the coordinate information of the motion input related to the operation, the coordinate information being transformed in the processes in S1-S2 (S11). Then, the motion input apparatus 10 determines whether or not the motion input related to the operation detected in the processes in S1-S2 satisfies a condition of the mode switchover to the invalid status from the valid status (S12). An in-depth description of the process in S12 will be made later on by use of FIGS. 6D-6F.

The motion input apparatus 10, if the motion input related to the operation detected in the processes in S1-S2 satisfies the condition of the mode switchover to the invalid status from the valid status (S12-S13, YES), switches over the status of the non-contact type UI function to the invalid status, and finishes the mode switchover process (S17). The motion input apparatus 10 switches over, e.g., the status of the non-contact type UI function, which is retained by the status retaining unit 104 to the invalid status, and stands by till being triggered by a next input event or a time event.

Whereas if the motion input related to the operation detected in the processes in S1-S2 does not satisfy the condition of the mode switchover to the invalid status from the valid status (S12-S13, NO), the motion input apparatus 10 determines the operation on the UI object displayed on the screen (S14). The determination as to the operation on the UI object displayed on the screen has been described in relation to the UI operation determining unit 107 in FIG. 3. The motion input apparatus 10 determines the operation on the UI object from, e.g., the display position of the UI object displayed on the screen, the status of the function and the positional relationship with the cursor coordinate Px associated with the motion input related to the operation in the processes in S1-S2.

The motion input apparatus 10, if the motion input related to the detected operation is the operation on the UI object in the process of S14 (S15, YES), executes the function associated with the UI object, such as depressing, e.g., the button component (S16). The motion input apparatus 10, after executing the process in S16, finishes the mode switchover process when in the valid status. Whereas if the motion input related to the detected operation is not the operation on the UI object (S15, NO), the motion input apparatus 10 finishes the mode switchover process and stands by till being triggered by the next input event or the time event.

Herein, the processes in S12-S13 and S17 executed by the motion input apparatus 10 are given by way of one example of switching over, when a position of an motion part remains away from a predetermined effective area continuously for a predetermined period of time, to an invalid status to invalidate an operation based on a motion input of the user with respect to an operation object displayed on a display unit. Further, the CPU 11 etc. of the motion input apparatus 10 executes the processes in S12-S13 and S17 by way of one example to switch over, when the position of the motion part remains away from the predetermined effective area continuously for the predetermined period of time, to the invalid status to invalidate the operation based on the motion input of the user with respect to the operation object displayed on the display unit.

Moreover, the process in S11 executed by the motion input apparatus 10 is one example of displaying a cursor in a display area on the display unit in association with acquired positional information of the operation part. Furthermore, the CPU 11 etc. of the motion input apparatus 10 executes the process in S11 by way of one example to display the cursor in the display area on the display unit in association with the acquired positional information of the operation part.

Next, the mode switchover process when the non-contact type UI function is in the invalid status will be described with reference to a flowchart illustrated in FIG. 6C. In the flowchart illustrated in FIG. 6C, the motion input apparatus 10 displays the cursor corresponding to the motion input related to the detected operation in the position coordinate Px on the display screen of the LCD 15a etc. on the basis of, e.g., the coordinate information transformed in the processes in S1-S2 (S21). The motion input apparatus 10 displays the cursor by taking, as the display mode of the cursor when in the invalid status, any one of, e.g., the outline alone, the semi-transparency, the meshed form and the gray-out in coloring of the display cursor or the combination thereof. The motion input apparatus 10 displays the cursor in the display mode enabling the invalid status to be explicitly indicated as illustrated in the explanatory diagram of, e.g., FIG. 5.

The motion input apparatus 10 determines whether or not the motion input related to the operation detected in the processes in S1-S2 is, e.g., the operation on the UI object displayed on the screen. For example, the motion input apparatus 10 determines the operation from the display position of the cursor associated with the motion input related to the operation, the state of the UI object, the display position of the UI object, etc. (S22). Note that the determination as to the operation in S22 is a determination for switching over the status of the non-contact type UI function to the valid status from the invalid status. Hence, this operation is referred to as a “temporary operation” determination as illustrated in FIG. 6C. The motion input apparatus 10, if the motion input related to the operation detected in the processes in S1-S2 is deemed not to be the “temporary operation” (S23, NO), finishes the mode switchover process and stands by till being triggered by the next input event or the time event.

In the explanatory example in FIG. 5, an action deemed to the “temporary operation” can be exemplified by a movement of the display position of the cursor into the area from outside the area over the border of the area with respect to the UI objects displayed in the display areas A1-A3. The motion input apparatus 10, if the motion input related to the operation detected in the processes in S1-S2 is deemed to be the “temporary operation” (S23, YES), determines whether or not a temporary operation target UI object is identical with the UI object already undergoing the action deemed to be the temporary operation (S24). The motion input apparatus 10, if the motion input related to the operation determined to be the “temporary operation” in the process in S22 is the operation on the UI object different from the UI object already deemed to be the temporary operation (S24, YES), resets an already-counted temporary operation count to “0” (S26). Then, the motion input apparatus 10 advances to a process in S27.

Whereas if the motion input related to the operation determined to be the “temporary operation” in the process in S22 is the operation on the UI object identical with the UI object already deemed to be the temporary operation (S24, NO), the motion input apparatus 10 advances to a process in S25.

In the process in S25, the motion input apparatus 10 determines the time for the motion input related to the operation determined to be the “temporary operation” in the process in S22. The motion input apparatus 10 calculates elapsed time for the motion input related to the operation determined to be the “temporary operation” in the process in S22 from, e.g., the history information etc with respect to the UI object already deemed to be the temporary operation. Then, the motion input apparatus 10 sets the elapsed time as measurement time T, and compares the measurement time T with a threshold value (S25). Herein, as for the threshold value, it may be sufficient that a period of time for operating the UI object intentionally repeatedly for the motion input related to the operation is experimentally measured beforehand and set as the threshold value. For example, if excessive of the threshold value obtained from the experimentally measured time, the motion input determined to be the “temporary operation” in the process in S22 can be deemed to be what the operation accidentally occurs a plural number of times.

The motion input apparatus 10 compares the measurement time T with the threshold value and, if the measurement time T exceeds the threshold value (S25, YES), deems the already counted temporary operation count as an unintentional operation count, and resets the operation count to “0” (S26). Whereas if the measurement time T does not exceed the threshold value (S25, NO), the motion input apparatus 10 advances to S27.

In the process in S27, the motion input apparatus 10 refers to the operation (temporary operation) count about the UI object, which is stored, e.g., in the predetermined area of the main storage unit 12, and determines whether the operation count is “0” or not. For example, if the “temporary operation” determination for the UI object has already been made, the operation count can be determined not to be “0” because the history information containing the time information is stored in the predetermined area of the main storage unit 12.

The motion input apparatus 10, in the process in S27, if the “temporary operation” count for the UI object is “0” (S27, YES), advances to a process in S28 and resets the measurement time T. For example, the motion input apparatus 10 deletes the history information with respect to the “temporary operation” on the UI object, the history information being stored in the predetermined area of the main storage unit 12. Then, in order to measure the measurement time T for the motion input related to the operation determined to be the “temporary operation” in the process in S22, the motion input apparatus 10 stores the new history information in the predetermined area of the main storage unit 12. Namely, the motion input apparatus 10 starts measuring a new measurement time T originating from the motion input related to the operation determined to be the “temporary operation” in the process in S22

The motion input apparatus 10, in the process in S27, whereas if the “temporary operation” count for the UI object is not “0” (S27, NO), advances to a process in S29. In the process in S29, the motion input apparatus 10 stores, e.g., the history information with respect to the motion input related to the operation determined to be the “temporary operation” in the process in S22 in the predetermined area of the main storage unit 12. Then, the motion input apparatus 10 increments, e.g., the count value of the temporary operation count by “1”, and advances to a process in S2A.

In the process in S2A, the motion input apparatus 10 compares, e.g., the count value of the “temporary operation” count for the UI object with the threshold value. The threshold value in S2A is a threshold value for switching over the non-contact type UI function to the valid status on the basis of, e.g., a count of the motion inputs related to the operations conducted on the UI object. Herein, the threshold value may be provided per UI object displayed on the screen. For example, in the case of the object being easy to cause the accidental determination to be made, it can be exemplified to increase the threshold value to make it hard to switch over to the valid status due to the detected operation count. Further, in the case of the object not being hard to cause the accidental determination to be made, it can be exemplified to set, e.g. to “1”, a determination threshold value for switching over to the valid status.

The motion input apparatus 10, if the count value of the “temporary operation” count for the UI object is smaller than the threshold value (S2A, NO), finishes the mode switchover process and stands by till being triggered by the next input event or the time event. The motion input apparatus 10, whereas if the count value of the “temporary operation” count for the UI object is equal to or larger than the threshold value (S2A, YES), switches over the non-contact type UI function to the valid status (S2B). Then, the motion input apparatus 10 notifies the status retaining unit 104 that the non-contact type UI function is in the valid status, and terminates the mode switchover process.

Herein, the processes in S22-S2B executed by the motion input apparatus 10 are given by way of one example of restoring, when detecting the operation satisfying a predetermined operation condition for the operation object displayed on the display unit from the acquired position of the motion part, the status from the invalid status to invalidate the operation based on the motion input of the user to the valid status to validate the operation based on the motion input. Moreover, the CPU 11 etc. of the motion input apparatus 10, when detecting the operation satisfying the predetermined operation condition for the operation object displayed on the display unit from the acquired position of the motion part, executes the processes in S22-S2B byway of one example to restore the status from the invalid status to invalidate the operation based on the motion input of the user to the valid status to validate the operation based on the motion input.

Further, the process in S21 executed by the motion input apparatus 10 is one example of displaying the cursor in the display area of the display unit in association with the acquired positional information of the operation part. Moreover, the CPU 11 etc. of the motion input apparatus 10 executes the process in S21 by way of one example to display the cursor in the display area of the display unit in association with the acquired positional information of the operation part.

Next, an in-depth description of the process in S12 illustrated in FIG. 6B will be made with reference to the flowcharts illustrated in FIGS. 6D-6F. The process in S12 illustrated in FIG. 6B is executed mainly by the invalid condition determining unit 102.

The flowchart depicted in FIG. 6D illustrates one example of a mode switchover determination process to the invalid status by use of the operation effective area illustrated in FIG. 4B. Further, the flowchart depicted in FIG. 6E illustrates one example of the mode switchover determination process by use of, e.g., detection of the face orientation. Still further, the flowchart depicted in FIG. 6F illustrates, e.g., one example of the mode switchover determination process on the condition that the display position of the cursor associated with the motion input related to the operation of the user passes through a plurality of areas on the display screen.

In the flowchart illustrated in FIG. 6D, the motion input apparatus 10 extracts, e.g., a face area of the user performing the motion input related to the operation from the time-series of the images captured by the camera 14a etc. (S31). The extraction of the face area can be exemplified by pattern matching with a face pattern dictionary etc. registered with characteristics of eyes, a nose, a mouth, etc. of the face against the captured image. The motion input apparatus 10 refers to the face pattern dictionary etc. registered with the characteristics of the eyes, the nose, the mouth, etc. of the face, the dictionary being stored in the auxiliary storage unit 13 etc., and thus extracts the face area of the user performing the motion input related to the operation by pattern-matching these characteristics against the captured image.

As for the face area extracted in the process in S31, the motion input apparatus 10 estimates the face area including a size and a position of the user's face on the captured image from, e.g., the plurality of captured images in the sequence of the time-series (S32). The motion input apparatus 10 estimates the face area of the user by making a comparison between these captured images, e.g., on condition that the face area of the user on the captured image exists in the vicinity of the center and that the size of the face area on the captured image is larger than the face area on each of other captured images. Then, the motion input apparatus 10 infers a position of the user's face in the real space, the face becoming an image capturing target, e.g., from the size and the position of the estimated face area on the captured image on the basis of performance data etc. of a focal length, a view angle, etc. of the camera 14a etc. (S33). The inference of the position of the user's face in the real space can be exemplified by inferring a vanishing point in the captured image and performing inverse transformation of one-point perspective transformation with respect to the vanishing point on the basis of the performance data etc. of the focal length, the view angle, etc. of the camera 14a etc.

Based on the position, inferred in the process in S33, of the user's face in the real space, the motion input apparatus 10 specifies, e.g., an operation effective area E illustrated in FIG. 4B (S34). FIG. 4B has already demonstrated how the operation effective area E is specified. The motion input apparatus 10 specifies a position V of the tracking target in the real space from a size and a position of an image of the tracking target operation part (e.g., the position of the hand) performing the motion input related to the operation, the image being contained in the time-series of the captured images (S35).

The motion input apparatus 10 determines, e.g., whether or not the tracking target position V specified in the process in S35 is contained in the operation effective area E (S36). The motion input apparatus 10, if the tracking target position V is contained in the operation effective area E (S36, YES), resets measurement time T2 (S37) and terminates this process. Herein, the measurement time T2 in the process in S37 is given by, e.g., a timer to measure a period for which the tracking target position V is not contained in the operation effective area E. Whereas if the tracking target position V is not contained in the operation effective area E (S36, NO), the motion input apparatus 10 advances to a process in S38.

In the process in S38, the motion input apparatus 10 starts the timer to measure the period for which the tracking target position V is not contained in the operation effective area E, thereby measuring the measurement time T2. Then, the motion input apparatus 10 compares the measurement time T2 with the threshold value and, if the measurement time T2 is equal to or smaller than the threshold value (S38, NO), finishes this process. Whereas if the measurement time T2 exceeds the threshold value (S38, YES), the motion input apparatus 10 shifts the status of the non-contact type UI function to the invalid status (S39) and finishes the process. Note that the threshold value to be compared with the measurement time T2 can be arbitrarily set corresponding to, e.g., the performance etc. of the motion input apparatus 10.

As illustrated in FIG. 6D, the motion input apparatus 10 determines the time about the tracking target moving outside the operation effective area E, whereby the status of the non-contact type UI function can be switched over to the invalid status from the valid status.

Next, the mode switchover determination process making use of detection of the face orientation will be described with reference to a flowchart illustrated in FIG. 6E. In the flowchart illustrated in FIG. 6E, processes in S41-S42 correspond to the processes in S31-S32 depicted in FIG. 6D. The motion input apparatus 10 extracts the face area of the user performing the motion input related to the operation, e.g., on the basis of the pattern matching with the face pattern dictionary etc. from the time-series of the images captured by the camera 14a etc. Then, the motion input apparatus 10 estimates the face area containing the size and the position of the user's face on the captured image, e.g., from the plurality of captured images in the time-series sequence on condition that the face area of the user on the captured image exists in the vicinity of the center.

The motion input apparatus 10, after extracting the face area of the user in the process in S42, further extracts part areas about the characteristic points of the eyes, the nose, the mouth, etc. within the face area. The extraction of the part areas may be attained, e. g., by checking against the face pattern dictionary etc. registered with the characteristic points of the eyes, the nose, the mouth, etc. and may also be attained by checking against a gradation pattern into which the part areas of pluralities of the eyes, the noses, the mouths, etc. are averaged. The motion input apparatus 10 calculates the face orientation of the user from a positional relationship between the respective part areas within the face area on the captured image (S43).

Herein, to give an example of calculating the face orientation, for instance, the face orientation to be estimated is set as a rotation matrix M, and the positional relationship between the averaged part areas is set as a matrix F expressed by coordinate values per part area. Then, the coordinates of the extracted part areas are configured as a matrix R, let g(x) be a transform function of the one-point perspective transformation through capturing the image, and a relationship between the coordinate matrix R of the extracted part areas, the rotation matrix M representing the face orientation and the matrix F can be expressed by the following mathematical expression (1).

g(MF)=R Mathematical Expression (1)

When transforming the mathematical expression (1) by use of an inverse transform function g′(x) of the one-point perspective transform function g(x) and an inverse matrix F⁻¹ of the matrix F, it is feasible to acquire the following mathematical expression (2) for obtaining the rotation matrix M representing the face orientation.

M=g′(R)F⁻¹ Mathematical Expression (2)

The motion input apparatus 10 substitutes, into the mathematical expression (2), the coordinate matrix R etc. of the respective part areas acquired from the time-series of the captured images, thereby making it possible to obtain the face orientation of the user performing the motion input related to the operation.

Next, the motion input apparatus 10 infers the position of the user's face in the real space, the face becoming the image capturing target, from the size and the position of the face area on the captured image, which are estimated in the process in S42, on the basis of performance data etc. of the focal length, the view angle, etc. of the camera 14a etc. (S44). The inference of the face position of the user in the real space has been described in the process in S33 of FIG. 6D.

The motion input apparatus 10 estimates a gazing position W on the plane of the screen of the LCD 15a etc. from the face orientation of the user and the face position of the user in the real space, which are acquired in the processes in, e.g., S43-S44 (S45). Note that a positional relationship between the image capturing device such as the camera 14a to capture the image of the motion input related to the operation and the display screen of the LCD 15a etc. on which to display the UI object, is to be previously specified. The motion input apparatus 10 obtains a straight line transformed by multiplying a straight line extending toward the display screen by the rotation matrix M calculated in the process in S43 from, e.g., the face position of the user in the real space, which is acquired in the process in S44. Then, the motion input apparatus 10 estimates, as the gazing position W, an intersecting point between the straight line transformed through the multiplication by the rotation matrix M calculated in the process in S43 and the plane of the screen of the LCD 15a etc.

The motion input apparatus 10 transforms the gazing position W estimated in the process in S45 into, e.g., the 2-dimensional coordinate on the plane of the screen and determines whether or not the transformed gazing position W exists within the area on the plane of the screen (S48). The motion input apparatus 10, if the gazing position W transformed into the 2-dimensional coordinate on the plane of the screen exists within the screen area (S46, YES), resets the measurement time T2 (S47) and finished the process. The measurement time T2 is given by a timer to measure a period for which the transformed gazing position W does not exist within the screen area. Whereas if the gazing position W transformed into the 2-dimensional coordinate on the plane of the screen does not exist within the screen area (S46, NO), the motion input apparatus 10 advances to a process in S48.

In the process in S48, the motion input apparatus 10 starts, e.g., the timer, thereby measuring a period for which the transformed gazing position W does not exist within the screen area. Then, the motion input apparatus 10 compares the measurement time T2 with the threshold value and, if the measurement time T2 is equal to or smaller than the threshold value (S48, NO), finished the process. Whereas if the measurement time T2 exceeds the threshold value (S48, YES), the motion input apparatus 10 shifts the status of the non-contact type UI function to the invalid status (S49) and terminates the process. Herein, the threshold value to be compared with the measurement time T2 can be arbitrarily set corresponding to the performance etc. of the motion input apparatus 10.

As illustrated in FIG. 6E, the motion input apparatus 10 determines the time with respect to the gazing position W outside the screen area of the LCD 15a etc., thereby enabling the switchover from the valid status to the invalid status of the non-contact type UI function. Note that in the process illustrated in FIG. 6E, the motion input apparatus 10, if unable to extract, e.g., the face area of the user and the respective part areas of the eyes, the nose, the mouth, etc. within the face area, may execute processing on the assumption that the user does not view the screen.

Next, the mode switchover determination process on condition that the cursor passes through the plurality of areas on the display screen, will be described with reference to a flowchart illustrated in FIG. 6F. In the flowchart illustrated in FIG. 6F, the motion input apparatus 10 displays, for example, N-number of determination areas Ri (i=1, 2, . . . , N) on the display screen of the LCD 15a etc. (S51). Then, the motion input apparatus 10 determines whether or not, e.g., the display position of the cursor moving on the display screen in the way of being associated with the motion input related to the operation passes through the determination area R1 (S52). It may be sufficient that the passage through the determination area Ri is determined when, e.g., the display position of the cursor moving on the display screen in the way of being associated with the motion input related to the operation moves into the display area from the outside of the display area of the determination area Ri.

The motion input apparatus 10, if the cursor passes through the determination area R1 (S52, YES), temporarily stores an indication value K (K=1, 2, . . . , N) indicating an area number of the determination area Ri in the predetermined area of the main storage unit 12 (S53). An initial value of the indication value K is set to, e.g., “1”. The motion input apparatus 10 stores “1” defined as the area number of the determination area R1 through which the cursor passes in the predetermined area of the main storage unit 12. Then, the motion input apparatus 10 resets, for instance, the measurement time T2 and starts the timer to measure a passage period for which the cursor passes through the determination area Ri (S54). The motion input apparatus 10 advances to a process in S55 after starting the timer. Note that the motion input apparatus 10, if the display position of the cursor moves without passing through the determination area R1 (S52, NO), also advances to the process in S55.

In the process in S55, the motion input apparatus 10 determines, for instance, whether or not the display position of the cursor moving on the display screen in the way of being associated with the motion input related to the operation passes through a determination area RK on the display screen. The motion input apparatus 10, if the cursor passes through the determination area RK (S55, YES), determines whether or not the indication value K indicating the area number of the determination area RK through which the cursor is determined to pass in the process in S55 is equal to the number N of the determination areas displayed on the screen (S56). Whereas if the display position of the cursor moves without passing through the determination area RK (S55, NO), the motion input apparatus 10 finishes the process.

In the process in S56, if the indication value K indicating the area number of the determination area RK is not equal to the number N of the determination areas displayed on the screen (S56, NO), the motion input apparatus 10 advances to a process in S57. In the process in S57, for example, the motion input apparatus 10 increments, by “1”, the indication value K indicating the area number of the determination area Ri, which is stored in the predetermined area of the main storage unit 12 in the process in S53. Then, the motion input apparatus 10 stores a value of “K+1” obtained by the increment again in the predetermined area of the main storage unit 12, and terminates the process.

Whereas if the indication value K indicating the area number of the determination area RK is equal to the number N of the determination areas displayed on the screen (S56, YES), the motion input apparatus 10 advances to a process in S58. In the process in S58, the motion input apparatus 10 compares the measurement time T2 given by, e.g., the timer started in the process in S54 with the threshold value and, if the measurement time T2 exceeds the threshold value (S58, YES), finishes the process. While on the other hand, if the measurement time T2 given by the timer started in the process in S54 is equal to or smaller than the threshold value (S58, NO), the motion input apparatus 10 shifts the status of the non-contact type UI function to the invalid status (S59), and terminates the process. It is to be noted that the threshold value to be compared with the measurement time T2 can be arbitrarily set corresponding to the performance etc. of the motion input apparatus 10.

Herein, the process in S51 executed by the motion input apparatus 10 is one example of displaying one or a plurality of operation objects for restoring the operation to the valid status in the display area of the display unit when in the invalid status. Further, the CPU 11 etc. of the motion input apparatus 10 executes the process in S51 by way of one example to display one or the plurality of operation objects for restoring the operation to the valid status in the display area of the display unit when in the invalid status.

As illustrated in FIG. 6F, the motion input apparatus 10 can switch over the status of the non-contact type UI function to the invalid status from the valid status on condition that the display position of the cursor passes through the plurality of determination areas Ri on the display screen in the sequence of the area numbers with the predetermined period of time.

As discussed above, the motion input apparatus 10 according to the embodiment can conduct the switchover to the valid status if satisfying the predetermined condition that the motion input related to the operation on the UI object displayed on the screen with the non-contact type UI function being in the invalid status is performed a predetermined or larger number of times. Herein, the motion input for the UI object when switched over to the valid status from the invalid status can be conducted in the same way as the motion input when the non-contact type UI function is in the valid status. Therefore, the motion input apparatus 10 according to the embodiment allows the user to perform the motion input related to the operation such as the specific hand gesture, hand sign and voice in relation to the mode switchover without being aware of the motion input, and can reduce the troublesomeness about the motion input and the user-unfriendliness. As a result, the motion input apparatus 10 according to the embodiment can enhance the user-friendliness to the non-contact type UI as compared with the case of conducting the motion input of the specific hand sign, hand gesture, etc.

Moreover, the motion input apparatus 10 according to the embodiment can set, as the condition for the mode switchover, e.g. the detection count, within the predetermined period of time, of the motion inputs related to the operations on the UI object displayed on the screen during the invalid mode. Hence, the motion input apparatus 10 according to the embodiment can prevent the mis-operation and the malfunction due to the unconscious action conducted regardless of the user's intention. As a result, the motion input apparatus 10 according to the embodiment can improve the usability of the motion input.

According to the motion input apparatus, it is feasible to provide the technology capable of improving the usability of the motion input.

### <<Non-Transitory Computer Readable Recording Medium>>

A program for making a computer, other machines and devices (which will hereinafter be referred to as the computer etc.) realize any one of the functions can be recorded on a non-transitory recording medium readable by the computer etc. Then, the computer etc. is made to read and execute the program on this non-transitory recording medium, whereby the function thereof can be provided.

Herein, the non-transitory recording medium readable by the computer etc. connotes a recording medium capable of accumulating information such as data and programs electrically, magnetically, optically, mechanically or by chemical action, which can be read from the computer etc. Among these non-transitory recording mediums, for example, a flexible disc, a magneto-optic disc, a CD-ROM, a CD-R/W, a DVD, a Blu-ray disc, a DAT, an 8 mm tape, a memory card such as a flash memory are given as those removable from the computer. Further, a hard disc, a ROM, etc. are given as the non-transitory recording mediums fixed within the computer etc.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A motion input apparatus comprising:
a display configured to display an operation object; and
one or more processors configured to:
acquire a position of a motion part related to a motion input of a user; and
switch over a status of the motion input apparatus, when detecting an operation satisfying a predetermined operation condition for the operation object displayed on the display from the acquired position of the motion part, to a valid status in which operations based on the motion input of the user are valid from an invalid status in which operations based on the motion input of the user are invalid.

2. The motion input apparatus according to claim 1, wherein the one or more processors are further configured to switch over the status of the motion input apparatus, when the position of the motion part is away from a predetermined effective area continuously for a predetermined period of time, to the invalid status in which operations based on the motion input of the user on the operation object displayed on the display are invalid.

3. The motion input apparatus according to claim 1, wherein the one or more processors are further configured to display a cursor in a display area of the display in association with the acquired position of the motion part, and
detect the operation on the operation object from a positional relationship between a display position of the operation object displayed on the display and a display position of the cursor.

4. The motion input apparatus according to claim 3, wherein the one or more processors display the cursor in a cursor display mode during the invalid status differently from a cursor display mode during the valid status.

5. The motion input apparatus according to claim 1, wherein the predetermined operation condition is a detection of consecutive operations within a predetermined period time with respect to one operation object displayed on the display.

6. The motion input apparatus according to claim 1, wherein the one or more processors validate a first user's motion input detected immediately after switchover to the valid status from the invalid status, and invalidate subsequent user's motion inputs during a predetermined period of time after detecting the first user's motion input.

7. The motion input apparatus according to claim 1, wherein the one or more processors detect a face orientation or a direction of a line of sight of the user performing the motion input, and the predetermined operation condition includes the detected face orientation or the detected direction of the line of sight of the user being directed toward the operation object displayed on the display.

8. The motion input apparatus according to claim 1, wherein the one or more processors measure a degree of how much the operation is deemed to be an operation on the operation object displayed on the display, and the predetermined operation condition includes the measured degree exceeding a predetermined threshold value.

9. The motion input apparatus according to claim 3, wherein the one or more processors display one or more cursors, each of the cursors being allocated to one motion part having a moving velocity exceeding a predetermined value among a plurality of acquired motion parts corresponding to the motion inputs of the user, and
detect a motion part satisfying a predetermined motion condition among the motion parts for which the cursors are allocated and displayed, as a motion part of the motion input during the valid status.

10. The motion input apparatus according to claim 9, wherein the one or more processors change a mode of the cursor display according to a moving velocity per motion part.

11. The motion input apparatus according to claim 1, wherein the one or more processors are further configured to display one or a plurality of operation objects for switching over the status of the motion input apparatus to the valid status in a display area of the display during the invalid status, and
the predetermined operation condition is a detection of a predetermined number of operations based on the motion inputs of the user within a predetermined period of time with respect to the one operation object displayed on the display, or the motion inputs of the user in a predetermined sequence within the predetermined period of time with respect to the plurality of operation objects displayed on the display.

12. The motion input apparatus according to claim 2, wherein the one or more processors detect a face orientation or a direction of a line of sight of the user performing the motion input, and switch over the status of the motion input apparatus to the invalid status in which operations are invalid when the detected face orientation or the detected direction of the line of sight of the user has not been kept directed toward the operation object displayed on the display continuously for a predetermined period of time.

13. The motion input apparatus according to claim 2, wherein the predetermined effective area is set on the basis of an associative relationship between a position of the user performing the motion input and a display area of the display on which the operation object is displayed.

14. The motion input apparatus according to claim 2, wherein the one or more processors are further configured to detect a specific hand sign or a specific hand moving trajectory,
detect a specific voice, and
switch over the status of the motion input apparatus to the invalid status in which operations are invalid, when the specific hand sign, the specific hand moving trajectory or the specific voice is detected.

15. The motion input apparatus according to claim 3, wherein the one or more processors detect the cursor moving within a predetermined period of time in a specific area of the display, and switch over the status of the motion input apparatus to the invalid status in which operations are invalid.

16. A computer-readable recording medium having stored therein a program for causing a computer configured to be connected to a display for displaying an operation object to execute a process comprising:
acquiring a position of a motion part related to a motion input of a user; and
switching over a status of the computer, when detecting an operation satisfying a predetermined operation condition for the operation object displayed on the display from a position of the motion part acquired in the acquiring, to a valid status in which operations based on the motion input of the user are valid from an invalid status in which operations based on the motion input of the user are invalid.

17. A motion input method comprising:
acquiring, by a processor of a computer configured to be connected to a display for displaying an operation object, a position of a motion part related to a motion input of a user; and
switching over a status of the computer, by the processor, when detecting an operation satisfying a predetermined operation condition for the operation object displayed on the display from a position of the motion part acquired in the acquiring, to a valid status in which operations based on the motion input of the user are valid from an invalid status in which operations based on the motion input of the user are invalid.
